(19) United States
(12) Patent Application Publication
(10) Pub. No.: US 2026/0289182 A1
(43) Pub. Date: Sep. 24, 2026

(54) SYSTEM

(71) Applicant: SoftBank Group Corp., Tokyo (JP)

(72) Inventor: Kaori NAKAMURA, Tokyo (JP)

(73) Assignee: SoftBank Group Corp., Tokyo (JP)

(21) Appl. No.: 19/567,364

(22) Filed: Mar. 16, 2026

(30) Foreign Application Priority Data
Mar. 19, 2025 (JP) 2025-045114

(51) Int. Cl. G06F 40/40; G06F 40/284; G06F 40/30

(52) U.S. Cl. CPC G06F 40/40; G06F 40/284; G06F 40/30

(57) ABSTRACT

A system includes a processor that is configured to generate a prompt sentence for instructing a generative AI model to analyze information input by a user using the generative AI model, input the generated prompt sentence into the generative AI model to analyze content of the information, compare an analysis result with existing data stored in a database to calculate a relevance score, output a warning when the processor determines, based on an evaluation result derived from the relevance score, that reliability of the information is low, and analyze an emotional state of the user and adjust a warning output method based on the emotional state.

### CROSS-REFERENCE TO RELATED APPLICATION

This application is based on and claims priority under 35 USC 119 from Japanese Patent Application No. 2025-045114 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional information verification and warning systems generally analyze user-input information and compare the analysis result with stored data to estimate the reliability of the information. However, such systems typically output uniform warnings without considering the emotional state of the user, for example, whether the user is calm, anxious, or agitated. As a result, the warning may be ignored, misunderstood, or may even increase the user's anxiety, thereby reducing the effectiveness of the warning. Furthermore, systems that simply pass user-input information directly to an AI model without generating an appropriate prompt may fail to obtain accurate or relevant analysis results, which can lead to inappropriate reliability assessments. Accordingly, there is a need for a system that can (i) generate suitable prompts for a generative AI model to reliably analyze user-input information, (ii) evaluate the reliability of the information based on comparison with accumulated data, and (iii) output a warning in a manner that is adaptively controlled in accordance with the emotional state of the user.

### SUMMARY

In order to solve the above-described problems, an aspect of the present invention provides a system comprising a processor, wherein the processor is configured to generate a prompt sentence for instructing a generative AI model to analyze information input by a user using the generative AI model, input the generated prompt sentence into the generative AI model to analyze content of the information, compare an analysis result with existing data stored in a database to calculate a relevance score, and output a warning when the processor determines, based on an evaluation result derived from the relevance score, that reliability of the information is low. The processor is further configured to analyze an emotional state of the user and adjust a warning output method based on the emotional state, for example, by selecting a visual or auditory presentation mode, modifying intensity or frequency of the warning, or changing wording or layout of the warning message in response to the detected emotional state. In some embodiments, the processor is configured to provide an interface that receives input from the user in real time and to provide the warning to the user visually or auditorily and to adjust a display method of the warning according to the emotional state of the user.

The term “system” refers to an arrangement of hardware and software components including at least one processor and, optionally, memory, storage, communication interfaces, and user interfaces, which cooperate to execute the processing described in the claims.

The term “processor” refers to any hardware device or combination of devices capable of executing instructions, such as a central processing unit (CPU), a graphics processing unit (GPU), a digital signal processor (DSP), a microcontroller, or a plurality of such devices operating together.

The term “generative AI model” refers to a machine learning model, such as a large language model or other generative model, that is trained to generate or transform data, including but not limited to natural language text, based on input data and learned parameters.

The term “prompt sentence” refers to a text or structured input sequence generated for the purpose of instructing a generative AI model regarding how to analyze, transform, or respond to information input by a user.

The term “information input by a user” refers to any data provided by the user to the system, including but not limited to text, voice input converted into text, or other content that is subject to analysis by the generative AI model.

The term “analyze content of the information” refers to processing the information to extract meaning, structure, attributes, or other features, such as topics, entities, sentiments, or factual claims, using the generative AI model.

The term “analysis result” refers to data generated by the generative AI model or by subsequent processing, representing an outcome of analyzing the user-input information, such as extracted features, classifications, scores, or summaries.

The term “database” refers to any structured data storage system, including relational databases, key-value stores, document stores, or other organized repositories, in which existing data is stored for comparison with analysis results.

The term “existing data” refers to data that has been previously stored in the database before the current analysis, including but not limited to verified information, reference records, historical logs, or other baseline data against which new information is evaluated.

The term “relevance score” refers to a quantitative value indicating a degree of correspondence, similarity, or relatedness between the analysis result and the existing data stored in the database.

The term “evaluation result derived from the relevance score” refers to a determination made by the processor, such as a classification or decision, based at least on the relevance score, regarding a property of the user-input information, including its reliability.

The term “reliability of the information” refers to a likelihood or degree to which the information is judged to be accurate, trustworthy, or consistent with the existing data stored in the database.

The term “warning” refers to any notification, message, or signal output by the system to inform the user that the reliability of the information is low or that caution should be exercised in relying on the information.

The term “output a warning” refers to causing a warning to be presented or transmitted to the user through one or more output channels, such as a display device, speaker, or communication interface.

The term “emotional state of the user” refers to a psychological or affective condition of the user, such as calmness, stress, anxiety, excitement, or other emotional conditions, as estimated or inferred by the system based on user behavior, input content, biometric data, or other observable indicators.

The term “analyze an emotional state of the user” refers to processing data related to the user, including text, voice, interaction patterns, or sensor outputs, to estimate or classify the user's emotional state.

The term “warning output method” refers to a manner or mode in which the warning is presented to the user, including choice of modality (visual or auditory), format, intensity, frequency, timing, or wording of the warning.

The term “adjust a warning output method” refers to modifying one or more parameters of the warning output method, such as switching between visual and auditory output, changing color, size, volume, timing, or message style, based on the analyzed emotional state of the user.

The term “interface that receives input from the user in real time” refers to a user interface provided by the system that accepts user input with substantially no intentional delay beyond processing and transmission time, such that the system can analyze and respond to the input contemporaneously with the user's operation.

The term “provide the warning to the user visually or auditorily” refers to presenting the warning through visual means such as text, icons, or graphics on a display, or through auditory means such as spoken messages or sounds output by a speaker or audio device.

The term “display method of the warning” refers to specific visual presentation parameters of the warning, including layout, color, size, emphasis, animation, or other visual attributes used when the warning is shown to the user.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

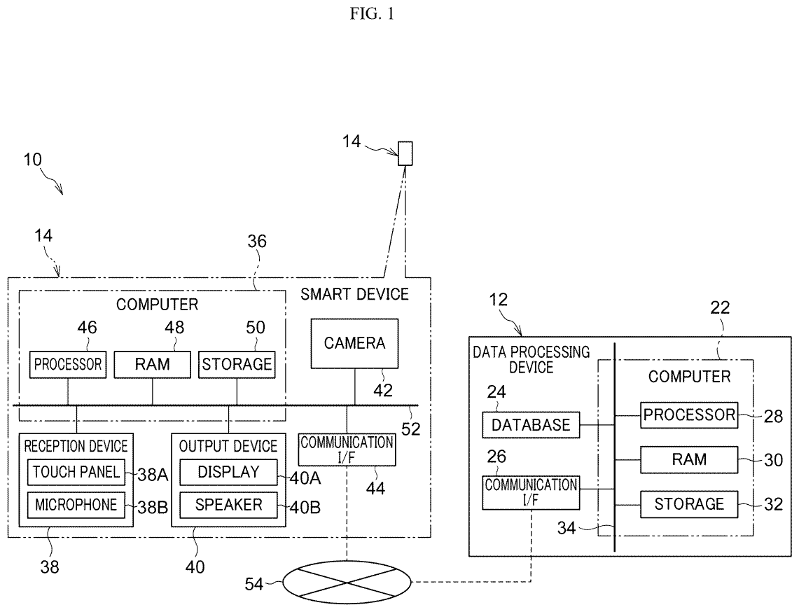

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

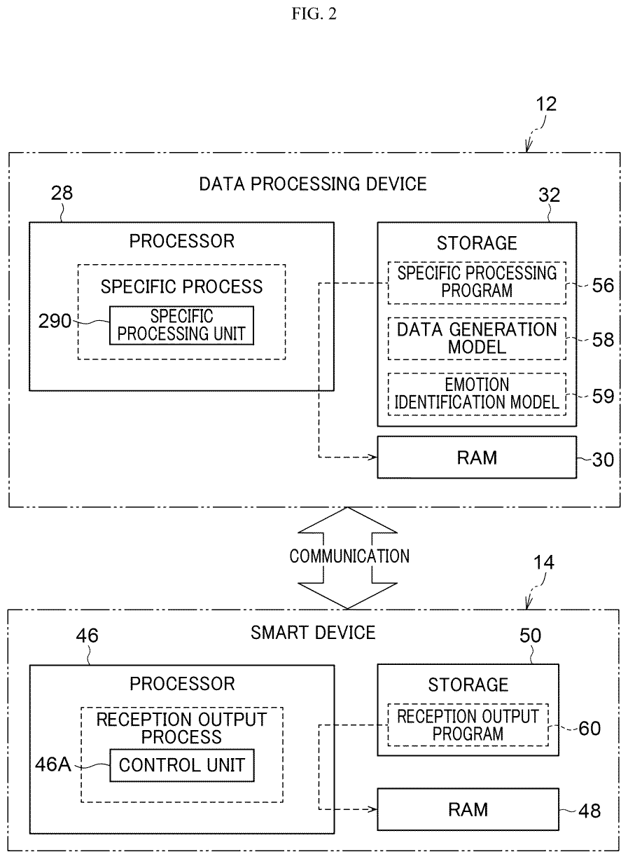

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information processing systems that evaluate relevance or reliability of user-input text with respect to existing data collections typically rely on simple keyword matching, rule-based heuristics, or shallow statistical methods. Such systems often exhibit several technical shortcomings in computer-implemented text analysis and alerting pipelines.

First, conventional systems frequently perform text analysis and similarity evaluation in separate, loosely coupled components, which results in redundant processing, increased latency, and inefficient utilization of computational resources. For example, raw text may be repeatedly tokenized, normalized, and indexed by different subsystems, leading to unnecessary processor load and memory consumption.

Second, these systems generally operate on low-dimensional or sparse representations (such as term-frequency vectors), which degrade the accuracy of relevance scoring, especially for semantically rich or context-dependent text. As a result, the computer system may generate false positive or false negative warnings regarding the relevance or reliability of the user's input, thereby reducing the technical effectiveness of automated decision support.

Third, conventional systems typically do not exploit generative artificial intelligence models to produce structured information from unstructured text via prompt-driven natural language processing. Because of this, the computer is not effectively leveraging advanced language representations to generate high-quality numerical feature vectors for similarity calculation against existing information sets stored in vector-capable databases.

Fourth, existing systems generally output warnings in a static and uniform manner, without dynamically adjusting the warning modality or intensity based on a user's emotional state inferred from interaction data. This leads to suboptimal human-computer interaction: users may ignore critical alerts or feel overloaded by frequent notifications, which in turn degrades the practical performance of the overall computer system as an information support tool.

Accordingly, there is a need for a computer-implemented technique that (i) integrates generative artificial intelligence models into the processing pipeline by automatically generating prompt sentences and obtaining structured information from user text, (ii) converts such structured information into numerical vector representations suitable for efficient similarity computation against stored vectors in a vector-search-capable storage device, and (iii) adjusts warning output modes based on an analysis of the user's emotional state. By addressing these issues, the invention aims to improve the technical functioning of the computer system itself in terms of relevance evaluation accuracy, processing efficiency, latency, and adaptive user notification behavior.

The specific processing by the specific processing unit 290 of the data processing device 12 in Example 1 is realized by the following means.

The present invention provides a server comprising a processor configured to receive character information input by a user from a terminal device, generate a prompt sentence for causing a generative information processing model to analyze content of the character information, input the prompt sentence and the character information into the generative information processing model to obtain structured information regarding the character information, generate a numerical vector as a feature quantity of the character information based on the structured information, compare the numerical vector with a plurality of numerical vectors stored in association with an existing information set held in a vector-search-capable storage device to calculate a relevance score indicating relevance between the character information and the existing information set, generate warning information indicating that relevance or reliability of the character information is low when the relevance score is lower than a predetermined criterion, output the warning information visually or auditorily to the user terminal, analyze an emotional state of the user based on input content or operation information from the user, adjust a presentation mode of the warning output according to the emotional state, and perform sequential processing from input of the character information to calculation of the relevance score and presentation of the warning information by connecting the user terminal and the processor via real-time communication. This enables the computer system to more efficiently and accurately evaluate semantic relevance of user-input information using prompt-driven generative artificial intelligence, to perform high-dimensional vector similarity computation against stored information sets with reduced latency, and to adaptively control warning output based on user state so as to improve overall system performance and usability in a technically meaningful way.

The term “character information” refers to digital text data composed of characters or symbols that is input by a user through an input interface of a terminal device and processed by the system as a unit of analysis.

The term “terminal device” refers to an information processing apparatus, such as a personal computer, a mobile communication device, or another user-operated computing device, that provides an interface for user input and output and communicates with a server via a communication network.

The term “prompt sentence” refers to a text instruction or query generated by the system for input to a generative information processing model, the text instruction specifying a processing task such as analysis, extraction, or summarization of character information.

The term “generative information processing model” refers to a machine-learned model that performs natural language processing, including generation and analysis of text, in response to input text such as a prompt sentence, and that outputs information such as structured data, classifications, or summaries.

The term “structured information” refers to information derived from character information by the generative information processing model and organized into a predefined format, such as fields for keywords, topics, summaries, or other labeled elements that can be programmatically accessed and processed.

The term “numerical vector” refers to a multi-dimensional array of numerical values that encodes features of character information or structured information, and that is suitable for mathematical operations such as similarity computation or clustering.

The term “feature quantity” refers to a representation of one or more characteristics of character information or structured information expressed as numerical data, including but not limited to elements of a numerical vector used for similarity evaluation.

The term “existing information set” refers to a collection of previously stored information items, such as documents, records, or text entries, that are stored in association with corresponding numerical vectors in a storage device and used as a reference for relevance evaluation.

The term “vector-search-capable storage device” refers to a storage apparatus or subsystem, including associated control logic, that stores a plurality of numerical vectors and supports search or retrieval operations based on similarity between numerical vectors, such as nearest-neighbor search in a vector space.

The term “relevance score” refers to a numerical value calculated by comparing a numerical vector corresponding to current character information with one or more numerical vectors corresponding to an existing information set, the numerical value indicating a degree of semantic similarity or relatedness.

The term “predetermined criterion” refers to a threshold value or rule defined in advance, for example a numerical threshold applied to a relevance score, that is used by the system to make a decision such as whether to generate warning information.

The term “warning information” refers to data representing a notification, message, or alert indicating that relevance or reliability of character information is below the predetermined criterion or otherwise requires attention from the user.

The term “warning output” refers to a process or result of presenting warning information to a user via an output interface, including visual presentation on a display or auditory presentation through a sound output device.

The term “emotional state” refers to an inferred condition of a user's affect, attitude, or mood, estimated by the system based on user input content, interaction patterns, or other observable signals, and used to adjust behavior of the system.

The term “presentation mode of the warning output” refers to a manner or style in which warning information is provided to the user, including parameters such as modality, intensity, timing, layout, or linguistic tone, which may be varied according to the user's emotional state.

The term “real-time communication” refers to bidirectional or unidirectional data transfer between a terminal device and a server over a communication network with latency sufficiently low that user input and corresponding system output can be exchanged and processed without perceptible delay to a human user.

The term “sequential processing” refers to an operation sequence in which the system performs, in a defined order, reception of character information, analysis via a generative information processing model, generation of a numerical vector, calculation of a relevance score, and presentation of warning information as part of a single processing flow.

In one embodiment, a server cooperates with a terminal and a user to implement the claimed system on conventional computer hardware extended with specialized software components for prompt-driven natural language processing and vector-based similarity computation.

A server includes at least one central processing unit (CPU), a main memory, a non-volatile storage device such as a solid-state drive, and a network interface controller. The server executes an operating system such as a general-purpose server operating system and runs one or more application programs that implement a web application framework, an application programming interface (API) layer, a prompt generation module, a generative AI model interface module, a feature vector generation module, a vector search module, a relevance evaluation module, a warning control module, and an emotional state analysis module.

A terminal includes a processor, a memory, a display, an input device such as a keyboard or touch panel, an audio output device such as a speaker, and a network interface. The terminal executes a web browser or a native application that provides an input field for character information and a user interface for displaying warnings and analysis results.

A user operates the terminal to input character information, to view presented warnings, and to modify the character information in response to such warnings.

In one configuration, the server uses a web server such as a general-purpose HTTP server in combination with an application framework such as a scripting language framework or a compiled language framework. The server exposes a network-accessible API endpoint over a secure protocol for receiving character information from the terminal and for returning analysis and warning information.

The server stores an existing information set in a storage subsystem that includes a relational database management system, a key-value store, or a specialized vector database. The server stores, in association with each stored text item of the existing information set, a numerical vector representing semantic features of that text item. The server uses a database extension or a vector index data structure, such as an approximate nearest neighbor index based on locality-sensitive hashing or hierarchical navigable small world graphs, to support efficient similarity search in a high-dimensional vector space.

In order to utilize a generative AI model, the server communicates with an external model hosting environment or an internal inference engine. The generative AI model is, in one embodiment, a deep neural network implementing a transformer architecture. The neural network includes an input embedding layer that maps tokens of a prompt sentence and character information into dense numerical vectors, a plurality of self-attention layers that compute attention-weighted combinations of token embeddings, and feedforward layers that transform these combinations into higher-level representations. The model is trained in advance on large-scale text corpora using supervised or self-supervised learning. During training, the model minimizes a loss function such as cross-entropy between predicted token distributions and ground truth tokens. An optimizer such as stochastic gradient descent with momentum, Adam, or another adaptive method updates model weights by backpropagation based on gradients of the loss function. Data augmentation techniques such as random masking of tokens, shuffling of sentence segments, or noise injection may be applied during training to improve generalization.

The server uses the generative AI model in inference mode. The server generates a prompt sentence to instruct the model to perform specific analysis tasks. For example, the server generates a prompt sentence such as:

“Analyze the following text. Extract the main keywords, the main topics, and a short summary. Output the result in a structured manner with fields ‘keywords’, ‘topics’, and ‘summary’. Text: ‘A proposal for market research on a new product.’”

The server, in another variant, generates a prompt sentence to generate a warning message. For example, the server generates a prompt sentence such as:

“The following user proposal has a low similarity score to past market research documents: 0.32 (threshold: 0.70). Generate a concise warning in English that tells the user that the proposal has low relevance to past data and suggests how to improve it. Output only the warning sentence.”

The server embeds the character information within the prompt sentence in a controlled position and format. By embedding the character information into the prompt sentence, the server constrains the generative AI model to produce structured analysis outputs rather than arbitrary free-form text, thereby improving computation predictability and facilitating subsequent programmatic parsing.

The server receives a text output from the generative AI model in response to the prompt sentence. The server parses the output to extract structured information such as a list of keywords, a set of topics, and a short summary that describes the content of the character information. The server internally represents the structured information using data structures such as arrays, lists, or dictionaries, which are stored in memory for further processing.

The server uses a feature vector generation module to convert the structured information into a numerical vector. In one embodiment, the server concatenates the original character information with the summary and topics, and then submits this combined text to an embedding model. The embedding model is implemented as another neural network, which may share the same transformer architecture as the generative AI model but is trained with a different objective to produce a fixed-dimensional vector representation of text. The embedding model maps the input text into a high-dimensional dense vector that captures semantic relationships in a continuous vector space. The server may normalize the resulting vector, for example by dividing by its Euclidean norm, to improve stability of cosine similarity calculations.

The server stores precomputed numerical vectors for the existing information set in the storage subsystem. Each numerical vector corresponds to a stored text item such as a prior report, a prior proposal, or another relevant document. The server indexes these vectors using a vector index structure. The server selects different vector index algorithms depending on expected query volume and latency constraints.

The server uses the vector search module to calculate a relevance score for the new character information. The server compares the numerical vector generated from the character information with the stored numerical vectors of the existing information set. The server may compute cosine similarity, inner product, or another metric as a measure of similarity. For example, the server computes a cosine similarity value between 0 and 1. The server may also aggregate similarities across a set of top-ranked existing items to derive a composite relevance score. Because the server operates on dense high-dimensional vectors derived from the generative AI model, the server can capture semantic similarity even when there are no exact keyword matches, thereby improving the technical accuracy of relevance evaluation compared to simpler bag-of-words approaches.

The server stores or accesses a predetermined criterion for relevance evaluation. The predetermined criterion may be a threshold value for the relevance score, such as 0.7, or may be a more complex decision rule that considers multiple factors such as maximum similarity, mean similarity, and dispersion of similarity values. The server compares the calculated relevance score with the predetermined criterion. When the relevance score is lower than the threshold, the server determines that relevance or reliability of the character information is low.

The server uses the warning control module to generate warning information in response to the low relevance determination. In one implementation, the server uses a template-based mechanism to construct deterministic warning messages. In another implementation, the server again uses the generative AI model with a dedicated prompt sentence to produce a context-sensitive warning that incorporates the calculated relevance score and optionally identifies missing or weakly represented topics. Because the server controls the prompt sentence and the parsing of the model's output, the server ensures that the warning is constrained to a single sentence or a bounded-length paragraph, thereby limiting network bandwidth and ensuring predictable display layout on the terminal.

The server supports multiple warning output modes, such as displaying colored text on a display device, overlaying a dialog box, producing an audible tone of a certain frequency and duration through a speaker, or combining these modes. The server sends warning information to the terminal together with auxiliary data such as the relevance score and a list of extracted keywords. The terminal uses its display controller to render text and graphical elements and uses its audio controller to output sound according to the warning information. Because the server delivers compact, structured warning information instead of raw model outputs or large text blocks, the communication load on the network is reduced, and the terminal can render warnings with lower processing overhead.

The server further analyzes an emotional state of the user. The server obtains input content and operation information from the terminal, such as the history of character information revisions, the time intervals between key inputs, frequency of deletion operations, or patterns of interaction with warning dialogs. The server processes such information using an emotional state estimation model. In one embodiment, the server uses a classifier neural network that takes as input features such as typing speed statistics, counts of error corrections, and sentiment scores of recent character information, and outputs probabilities for emotional states such as calm, frustrated, or hurried. The classifier may be implemented as a feedforward neural network or a recurrent neural network and may be trained on labeled interaction data using a loss function such as cross-entropy. By mapping user behavior metrics into an emotional state in this way, the server implements a technical adaptation mechanism that goes beyond simple rule-based thresholds.

The server adjusts a presentation mode of the warning output according to the estimated emotional state. For example, when the server determines that the user is in a frustrated state, the server may reduce the frequency of repeated warnings, may soften the wording of the warning, and may choose a non-intrusive visual style such as a small banner rather than a blocking dialog. When the server determines that the user is in a calm state or when the character information is highly unreliable, the server may increase the visual emphasis by using brighter colors or a larger font size. By dynamically adjusting presentation parameters such as timing, intensity, and layout, the server improves the effectiveness of warnings while avoiding excessive cognitive load. This adaptive behavior modifies internal control parameters and output data formats within the computer system and thereby changes the operation of the computer itself in response to user conditions.

The server connects to the terminal via a real-time communication channel over a communication network. The server maintains persistent or semi-persistent connections when appropriate, for example through WebSocket or other bidirectional protocols, to reduce connection establishment overhead. The server thereby reduces round-trip latency and allows near real-time feedback to the user. The server designs internal data structures and caching strategies so that once character information is received, the prompt generation, generative AI model calls, embedding computations, vector searches, and warning generation are executed as part of a unified processing flow residing within the server's memory, minimizing disk access and intermediate serialization. This integrated design reduces context-switching and duplicated preprocessing across modules and results in improved processing speed and reduced overall computational cost compared to implementations that treat these components as loosely coupled independent services.

In another embodiment, the server hosts the generative AI model locally instead of relying on an external model provider. In this configuration, the server stores the parameters of the transformer network on local storage and loads them into memory at startup. The server uses a hardware accelerator such as a graphics processing unit or a tensor processing unit to perform matrix multiplications and attention computations. The server may quantize model parameters to lower precision to reduce memory footprint and improve throughput. The server may also batch multiple inference requests and perform them concurrently on the hardware accelerator. These techniques result in lower average latency and higher throughput per unit hardware resource.

In yet another embodiment, the server employs different generative AI models or embedding models for different categories of tasks. For example, the server may use a larger and more expressive language model for generating detailed summaries and a smaller, more efficient embedding model for computing numerical vectors used in similarity calculations. The server chooses which model to invoke based on heuristics, configuration, or metadata about the character information, such as text length or detected domain. This dynamic model selection further improves computational efficiency and allows the system to scale to large numbers of concurrent users.

The server, by combining prompt-driven structured analysis, vector-based similarity search, and emotional-state-adaptive warning control in a single architecture, achieves a technical improvement over conventional systems that rely primarily on keyword matching or static rule-based alerts. The use of dense numerical vectors derived from generative AI outputs, together with specialized vector indices, reduces false positives and false negatives in relevance detection and accelerates similarity queries in high-dimensional spaces. The controlled use of prompt sentences and structured parsing enables the server to harness the flexibility of generative AI models while maintaining deterministic and machine-readable outputs, thereby improving reliability in an automated computing environment. The emotional state analysis module modifies internal parameters governing warning output, which in turn alters the scheduling and content of system outputs and leads to more effective alerting and better utilization of user attention as a limited system resource.

Through these configurations and variations, the server, the terminal, and the user cooperate in a computer-implemented system that not only automates aspects of text evaluation but also modifies core internal data structures, computation patterns, and communication behaviors of the computing devices. As a result, the system enhances processing speed, relevance evaluation accuracy, data management in high-dimensional vector spaces, and communication efficiency, and thereby improves the functioning of the underlying computer technology itself.

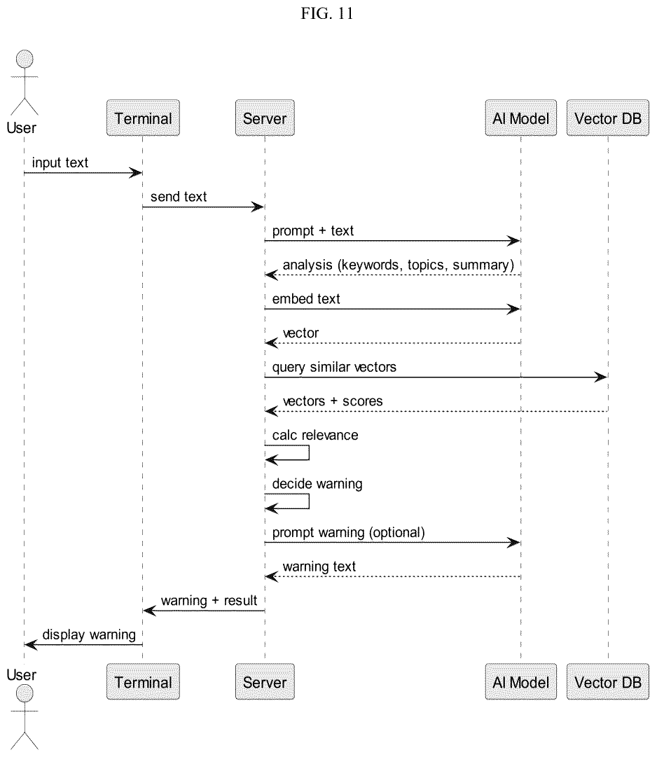

The following describes the processing flow using FIG. 11.

### Step 1

The user operates the terminal to input character information.

The terminal displays an input field on a screen and receives keystrokes or touch input from the user.

Input: raw keystrokes or touch events from the user.

The terminal converts these events into a text string and stores the text string in a memory buffer as character information.

Output: a completed text string representing the character information entered by the user.

### Step 2

The terminal prepares a request message for the server.

The terminal takes the text string as input and adds metadata such as a user identifier, a timestamp, and a language setting.

Input: the text string and locally available metadata.

The terminal formats these data elements into a structured message, for example a JSON object, and encapsulates the message in an HTTP request addressed to an API endpoint on the server.

Output: a network message containing the character information and metadata.

### Step 3

The terminal transmits the request message to the server.

The terminal uses a network interface to send the HTTP request over a communication network using a transport protocol.

Input: the network message prepared in Step 2.

The terminal passes the message to a network stack, which segments the data into packets and transmits them toward the server's network address.

Output: network packets carrying the character information to the server.

### Step 4

The server receives the request message from the terminal.

The server's network interface assembles incoming packets into the original HTTP request and passes the request to an application layer program.

Input: the network packets from the terminal.

The server parses the HTTP headers and body, verifies that the request conforms to an expected format, and extracts the character information and associated metadata.

Output: an internal representation of the character information and metadata stored in the server's memory.

### Step 5

The server performs initial preprocessing of the character information.

The server takes the extracted text string as input and applies normalization operations such as trimming whitespace, unifying line breaks, and optionally converting character encodings.

Input: the raw text string extracted in Step 4.

The server may also perform language detection by applying a statistical or machine-learned classifier to the text and recording a detected language code.

Output: a normalized text string and, optionally, a detected language code.

### Step 6

The server generates a prompt sentence for a generative AI model.

The server loads a prompt template from a configuration store and inserts the normalized text into a placeholder within the template.

Input: the normalized text string and a stored prompt template.

The server constructs a final prompt sentence such as:

“Analyze the following text. Extract the main keywords, the main topics, and a short summary. Output the result in a structured manner with fields ‘keywords’, ‘topics’, and ‘summary’. Text: ‘[normalized text]’.”

The server stores this prompt sentence as a string for later use.

Output: a complete prompt sentence instructing the generative AI model to analyze the character information.

### Step 7

The server sends the prompt sentence and character information to the generative AI model.

The server prepares a model request that includes the prompt sentence, model identification, and control parameters such as temperature and maximum output length.

Input: the prompt sentence from Step 6 and model parameters stored in configuration.

The server transmits this request to a model inference engine via an API, using a network protocol or an internal function call, and waits for a response.

Output: a model inference request issued to the generative AI model.

### Step 8

The server receives structured information from the generative AI model.

The generative AI model processes the prompt sentence and returns a text output that encodes structured data, such as keywords, topics, and a summary.

Input: the model response containing the text output.

The server parses the text response, identifies fields such as “keywords,” “topics,” and “summary,” and converts them into internal data structures such as lists or arrays.

Output: structured information objects containing extracted keywords, identified topics, and a summary description of the character information.

### Step 9

The server generates a numerical vector representing the character information.

The server takes the structured information and the normalized text as input and composes a combined analysis string, for example by concatenating the summary and topics with the original text.

Input: the structured information and the normalized text string.

The server sends this combined text to an embedding model that maps text into a fixed-length numerical vector. The embedding model outputs an array of real numbers. The server may normalize this vector, for example by scaling it to unit length.

Output: a numerical vector serving as a feature quantity of the character information.

### Step 10

The server retrieves numerical vectors corresponding to the existing information set.

The server connects to a storage subsystem that holds precomputed numerical vectors associated with stored text items.

Input: a query specifying that all or a subset of stored vectors should be considered for comparison.

The server reads the stored vectors and associated identifiers from the storage subsystem into memory, optionally using an index to limit the set of candidates.

Output: a collection of numerical vectors and metadata for the existing information set.

### Step 11

The server calculates similarity values between the new numerical vector and the stored numerical vectors.

The server takes the numerical vector for the current character information and the collection of stored vectors as input.

Input: the new numerical vector from Step 9 and the stored vectors from Step 10.

The server computes similarity metrics, such as cosine similarity, by performing arithmetic operations including dot products and norm calculations between the new vector and each stored vector.

Output: a list of similarity values, each associated with a corresponding stored information item.

### Step 12

The server derives a relevance score from the similarity values.

The server analyzes the list of similarity values and may select the maximum value, compute an average of the top k values, or apply another aggregation formula.

Input: the similarity values produced in Step 11.

The server converts this aggregated value into a single relevance score that expresses the degree of relatedness between the character information and the existing information set.

Output: a numerical relevance score.

### Step 13

The server evaluates the relevance score against a predetermined criterion.

The server retrieves a threshold value or decision rule from configuration and compares the relevance score with this threshold.

Input: the relevance score from Step 12 and the predetermined criterion.

The server determines whether the relevance or reliability of the character information is considered low by applying comparison operations such as “less than” or “greater than or equal to.”

Output: a binary or categorical decision indicating low relevance or sufficient relevance.

### Step 14

The server generates warning information when the relevance is low.

If the decision indicates low relevance, the server constructs warning content. The server may either apply a fixed template to insert the relevance score into a standard message or call the generative AI model again with a dedicated prompt sentence.

Input: the low relevance decision and the relevance score.

When using the generative AI model, the server creates a prompt sentence such as:

“The following user proposal has a low similarity score to past documents: [score] (threshold: [threshold]). Generate a concise warning in English that tells the user that the proposal has low relevance to past data and suggests how to improve it. Output only the warning sentence.”

The server obtains a generated warning text or constructs a template-based warning text and stores it as warning information.

Output: a warning message string indicating that relevance or reliability is low.

### Step 15

The server analyzes an emotional state of the user.

The server collects interaction data such as the number of times the user has revised the text, the time between successive submissions, and any other operation logs provided by the terminal.

Input: user interaction metrics and recent character information.

The server applies an emotional state estimation algorithm, which may include statistical thresholds or a classifier model, to map the metrics into one of several emotional states such as calm, neutral, or frustrated.

Output: an estimated emotional state label associated with the current user session.

### Step 16

The server adjusts a presentation mode of the warning output based on the emotional state.

The server takes the warning message and the estimated emotional state as input and selects presentation parameters such as display color, font size, position on the screen, and whether to include an audible alert.

Input: the warning message from Step 14 and the emotional state label from Step 15.

The server modifies a warning output descriptor data structure to include these parameters, thereby specifying how the warning should be presented on the terminal.

Output: a warning output descriptor that defines both content and modality of the warning.

### Step 17

The server sends the warning information and analysis result to the terminal.

The server composes a response message that includes the warning message, the relevance score, the extracted keywords and topics, and the warning output descriptor.

Input: the warning output descriptor, the structured information, and the relevance score.

The server formats these elements into a structured response and transmits the response to the terminal over the network using an HTTP response or a similar protocol.

Output: a network response containing all information necessary for the terminal to display the warning and analysis.

### Step 18

The terminal receives and parses the response from the server.

The terminal's network interface collects incoming packets, reconstructs the response message, and passes it to the application.

Input: the network response from the server.

The terminal parses the structured data, extracts fields such as the warning message, relevance score, keywords, topics, and presentation parameters, and stores them in application memory.

Output: internal data structures on the terminal representing warning content and analysis results.

### Step 19

The terminal presents the warning information and analysis results to the user.

The terminal uses the presentation parameters to control the display and, if specified, audio output.

Input: the warning message, relevance score, keywords, topics, and presentation parameters from Step 18.

The terminal renders the warning text on the display, for example in a colored banner or dialog, displays the relevance score and extracted information in designated areas of the screen, and may play an audible alert through a speaker.

Output: a visual and optionally auditory presentation to the user, enabling the user to perceive the low relevance state of the character information and to decide whether to modify and resubmit the text.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional enterprise communication monitoring systems typically rely on static rule sets, fixed keyword lists, or manually designed pattern-matching logic to detect problematic communications, such as messages involving low-reliability information or potential confidential information leakage. Such systems suffer from several technical limitations.

First, a conventional system generally analyzes message content using simple string matching or shallow heuristics that do not capture semantic meaning, user intent, or contextual nuance. As a result, many truly risky messages are not detected, while a large number of benign messages are falsely flagged, thereby degrading the effectiveness and precision of the monitoring function.

Second, a conventional system usually compares a current message against stored logs using basic filters or counters, without computing a structured similarity score or an anomaly score over a large corpus of historical communications. This limits the system's ability to identify deviations from normal communication patterns at scale, and makes it difficult to adapt dynamically to changes in communication style, topics, or organization-wide behavior.

Third, a conventional system typically outputs warnings in a uniform manner, regardless of the emotional state of a user. For example, a user who is already anxious or frustrated may receive a harsh or intrusive warning, which can cause the user to ignore the warning or respond negatively. Conversely, a calm user may need a more assertive notification to recognize the seriousness of a potential security risk. Existing systems do not technically integrate user emotion analysis into the warning generation pipeline.

Fourth, in many deployments, a conventional system does not exploit modern generative AI models to generate flexible prompt instructions, to perform deep semantic analysis, or to produce machine-interpretable risk assessments that can be programmatically combined with database-driven similarity and anomaly metrics. Computing resources in such systems are often underutilized or inefficiently used, and the architecture does not take advantage of scalable, model-based natural language processing in real time for large volumes of messages.

Consequently, there is a need for an improved computer-implemented system and method that: (i) automatically constructs and uses prompt sentences for a generative AI model to analyze semantic content and user intent of input information; (ii) integrates AI-based analysis with database-driven computation of relevance scores and anomaly scores based on accumulated historical data; (iii) programmatically determines reliability and security risk of the input information and generates alert information when appropriate; and (iv) analyzes a user's emotional state using the generative AI model and adapts the method and intensity of alert output based on the emotional state and the evaluated security risk. By addressing these issues in a unified architecture, the invention aims to improve the technical operation of communication monitoring systems, reduce false positives and false negatives, and enhance the responsiveness and effectiveness of real-time security oversight in computer-implemented communication environments.

The specific processing by the specific processing unit 290 of the data processing device 12 in Application Example 1 is realized by the following means.

The present invention provides a server comprising a processor and a storage device, the processor being configured to receive input information from a user via an input interface, generate a prompt sentence for analyzing the input information, and input the prompt sentence and the input information into a generative AI model to cause the generative AI model to analyze a semantic content and an intention of the input information, compare an analysis result from the generative AI model and the input information with past information stored in the storage device, and calculate a relevance score and an anomaly score based on similarity computation or anomaly detection computation, determine, based on the relevance score and the anomaly score, whether the input information deviates from a normal communication pattern or has a risk of confidential information leakage, and generate alert information when the input information is determined to have low reliability or high security risk, analyze an emotional state of the user from spoken content or text content using the generative AI model, and adjust an output method or notification content of the alert information according to the emotional state, perform communication processing to transmit the alert information to an administrator terminal or a monitoring terminal, and record at least the input information, the analysis result, the relevance score, the anomaly score, and the alert information in the storage device. This enables a computer-implemented communication monitoring system to perform deep semantic and contextual analysis of user messages using a generative AI model, to integrate such analysis with database-based similarity and anomaly metrics for precise reliability and security risk evaluation, and to adaptively control alert generation and presentation based on user emotion and risk level, thereby improving the technical performance, accuracy, and responsiveness of automated monitoring in an enterprise communication environment.

The term “server” refers to an information processing apparatus including at least one processor and at least one storage device, configured to execute programs for receiving, analyzing, and storing data, and for communicating with external terminals or systems over a communication network.

The term “processor” refers to a hardware computation unit, such as a central processing unit or a processing core, that executes instructions of a program to perform logical operations, arithmetic operations, data control, and communication control.

The term “storage device” refers to a physical or virtual storage resource, such as a memory device or a non-volatile storage device, configured to store data, programs, analysis results, scores, and alert information in an electronically readable form.

The term “user” refers to a human operator or an entity that inputs information into the system through an input interface, such as a communication client or a terminal device.

The term “input interface” refers to a hardware and software combination, such as an application programming interface, a graphical user interface, or a communication protocol endpoint, that receives input information from the user or a terminal device.

The term “input information” refers to data provided by the user, including at least one of text data, spoken content transcribed into text, metadata, or other communication content that is to be analyzed by the system.

The term “prompt sentence” refers to a text string or structured natural language instruction that is generated by the processor and supplied to a generative AI model in order to specify an analysis task or output format for processing the input information.

The term “generative AI model” refers to a machine learning model configured to perform natural language processing, including at least generation, interpretation, and analysis of text, based on a large number of learned parameters and trained on large-scale data.

The term “semantic content” refers to a meaning, topic, or conceptual information that is represented by the input information, as understood and expressed in a machine-interpretable form by the generative AI model.

The term “intention” refers to a purpose, objective, or communicative goal inferred from the input information, as determined by the generative AI model based on context and semantics.

The term “analysis result” refers to data produced by the generative AI model or by the processor, including at least one of classification labels, risk levels, explanatory text, detected terms, or other machine-interpretable outputs derived from the input information.

The term “past information” refers to data previously stored in the storage device, including historical communication records, prior analysis results, prior scores, and other related contextual data used for comparison with current input information.

The term “relevance score” refers to a numerical or categorical indicator computed by the processor that expresses a degree of similarity or relatedness between the input information and the past information stored in the storage device.

The term “anomaly score” refers to a numerical or categorical indicator computed by the processor that expresses a degree of deviation of the input information from a normal pattern, based on at least one of similarity computation, anomaly detection computation, or statistical analysis.

The term “similarity computation” refers to a computational operation that measures a closeness or similarity between representations of pieces of information, such as vector representations of text, using at least one metric such as cosine similarity, distance, or correlation.

The term “anomaly detection computation” refers to a computational operation that detects data points that deviate from a distribution of normal data, using at least one method such as thresholding, clustering, outlier detection, or machine learning-based anomaly detection.

The term “normal communication pattern” refers to a statistical or model-based representation of typical communication behaviors, topics, or message structures observed in past information and used as a reference for evaluating new input information.

The term “confidential information leakage” refers to an unauthorized or unintended disclosure of information that is designated as sensitive, private, secret, or restricted, from within an organization to an external party or an unauthorized internal party.

The term “reliability” refers to a degree to which the input information is considered accurate, trustworthy, or consistent with known data or normal patterns, as determined by the processor based on the relevance score, the anomaly score, or analysis results.

The term “security risk” refers to a likelihood or severity of harm to information security, including at least one of data leakage, policy violation, unauthorized access, or misuse of information, associated with the input information.

The term “alert information” refers to data generated by the processor in response to a detected condition of low reliability or high security risk, including at least one of a warning message, risk description, metadata, and identifiers of related input information.

The term “emotional state” refers to a psychological condition of the user, such as anxiety, frustration, calmness, or confidence, inferred from spoken content, text content, or associated metadata using the generative AI model.

The term “spoken content” refers to audio speech of the user that is processed by a speech recognition function and converted into text, or a representation of such speech, for further analysis by the generative AI model.

The term “text content” refers to a sequence of characters or symbols representing natural language, such as a message body or a chat entry, that is input by the user or derived from spoken content.

The term “output method” refers to a modality or style in which the alert information is presented, including at least one of a display on a screen, a sound, a vibration, a notification on a graphical user interface, or a message sent over a network.

The term “notification content” refers to a specific wording, structure, or detail level of a message that conveys the alert information to a recipient, such as a user or an administrator.

The term “communication processing” refers to control and execution of data transmission and reception over a communication network, including formatting of messages, protocol handling, and routing of alert information to external devices.

The term “administrator terminal” refers to a computing device operated by a management entity, such as a security administrator or system operator, that receives alert information and may present management interfaces.

The term “monitoring terminal” refers to a computing device used for observing or supervising system operation or communications, and configured to receive and display alert information for analysis or intervention.

The term “in-house communication medium” refers to an internal communication environment or platform, such as an enterprise messaging system, email system, or collaboration tool, through which the user exchanges messages within an organization.

The term “user interface” refers to a functional interface, including at least one of graphical, textual, or programmatic components, that allows the user to input information and view responses or notifications from the system in real time.

The term “visual notification” refers to presentation of alert information in a visual form, such as a dialog box, banner, icon, color change, or other visual indicator on a display device.

The term “auditory notification” refers to presentation of alert information in an audio form, such as a tone, spoken message, or other sound produced by an audio output device.

The term “notification medium” refers to a channel or device through which an alert is delivered, including at least one of a display device, a speaker, a mobile notification system, or an email channel.

The term “notification intensity” refers to a degree of strength or prominence of an alert, such as volume, brightness, size, repetition, or level of intrusion of a notification.

The term “notification frequency” refers to a rate or count of repeated alerts over time, which may be increased or decreased according to the emotional state of the user or a security risk of the input information.

In one embodiment, a server includes at least one processor, a main memory, a non-volatile storage device, and a network interface. The server executes a monitoring program implemented, for example, in a high-level language such as Python running on a general-purpose operating system. The server communicates with one or more terminals over a communication network using a secure communication protocol. Each terminal includes at least one processor, a memory, a display device, an input device such as a keyboard or a pointing device, and optionally an audio input/output device such as a microphone and a speaker. A user operates the terminal to exchange messages through an in-house communication medium, such as an enterprise messaging platform or web-based chat system, which is connected to the server.

The server stores a generative AI model in association with a model execution environment. In one example, the server accesses an external generative AI model through a model API. In another example, the server stores and executes a generative AI model locally. The generative AI model is implemented as a neural network such as a transformer-based language model having multiple layers of self-attention blocks, feed-forward networks, and learned embedding matrices. The model receives tokenized text as input and produces token-level or sequence-level output representing an analysis result. The server stores parameters of the generative AI model as weight matrices and bias vectors, which are adjusted through a training process performed on a large corpus of text data. During training, the server or an external training system minimizes a loss function such as a cross-entropy loss between predicted token distributions and ground-truth tokens. The training uses an optimization algorithm such as stochastic gradient descent or an adaptive gradient method. In some embodiments, the server performs fine-tuning of the generative AI model on domain-specific communication logs to improve detection of confidential information leakage and communication anomalies.

The server stores in the storage device a database implemented, for example, with a relational database management system. The database includes tables for messages, analysis results, scores, users, and alerts. The messages table stores, for each message, at least a message identifier, a sender identifier, a timestamp, a channel identifier, and a text content field. The analysis results table stores, for each message, an AI-generated risk level, a reason string, and a list or encoded representation of detected sensitive terms. The scores table stores a relevance score and an anomaly score for each message. The alerts table stores alert information including an alert identifier, a related message identifier, an alert type, a risk score, and alert generation time. The server defines indexes, such as text indexes and composite indexes, on the messages and scores tables to reduce query latency and improve retrieval performance during similarity computation and anomaly detection.

The server generates a monitoring program that orchestrates the interaction between the generative AI model, the database, and the communication subsystem. The server stores this program as one or more executable modules. One module manages reception of user messages via an application programming interface provided by the in-house communication medium. Another module generates a prompt sentence to be supplied to the generative AI model. Another module processes the output of the generative AI model, computes relevance scores and anomaly scores, and stores them in the database. Another module generates alert information and transmits the alert information to an administrator terminal or monitoring terminal.

The server uses the generative AI model to perform deep semantic and contextual analysis that is not achievable by simple rule-based systems. Specifically, the server converts each input message into a sequence of tokens using a tokenizer configured for the generative AI model. The server generates a prompt sentence that combines a fixed instruction part and the user's message. In one example, the server generates the following prompt sentence:

“The following text is an internal company communication message. Analyze it and evaluate the risk of confidential information leakage or policy violation. Return a JSON object with the keys ‘risk_level’ (‘low’, ‘medium’, or ‘high’), ‘reason’, and ‘detected_sensitive_terms’ (a list of strings).

Message: ‘I will send the detailed design documents and client pricing list for the new project to an external consultant this afternoon.’”

In another example, the server generates the following prompt sentence:

“Analyze the following internal company message and evaluate the risk of confidential information leakage. Output the risk level (low, medium, high) and a brief explanation. Message: ‘I will send the detailed project plan to an external partner today.’”

The server provides the prompt sentence and the user's message to the generative AI model by embedding the text into a high-dimensional space with learned embedding vectors, passing the embedded sequence through multiple transformer layers, and decoding the output sequence into text. The generative AI model produces an analysis result that includes at least a risk level and an explanation. Because the generative AI model processes multi-token context with self-attention and uses learned statistical regularities across large-scale data, the server can detect semantic patterns that do not rely on exact keyword matches, thereby improving detection precision and recall.

The server then performs structured computation with the analysis result and historical data. The server converts the input message and selected past messages into numerical feature vectors using a feature extraction method. In one embodiment, the server uses an embedding function of a language model to obtain dense vector representations of messages. In another embodiment, the server uses a text vectorization method that computes term frequency-inverse document frequency values for words or n-grams. The server stores these vector representations in the database or in an in-memory cache, using data structures such as arrays or sparse matrices. The server computes similarity measures such as cosine similarity between the current message vector and each past message vector. The server may implement a non-linear anomaly detection algorithm, such as an isolation forest or a clustering-based outlier detector, over these feature vectors to derive an anomaly score. By computing the relevance score and anomaly score in the feature space, the server can detect patterns of deviation that would not be apparent to a human reviewer using manual inspection or to a naïve keyword-based system.

The server combines the AI-derived risk level, the similarity-based relevance score, and the anomaly score according to predetermined or adaptive rules. The server may store rule parameters and thresholds in a configuration table. For example, the server may assign a numerical risk value to each AI risk level and calculate a combined score as a weighted sum of the AI risk value, the relevance score, and the anomaly score. The server may adjust the weights based on prior system performance, thereby tuning the system to reduce false positives or false negatives. The server determines that a message has low reliability or high security risk when the combined score exceeds a threshold. The server then generates alert information, including the original message text, the AI-generated explanation, the scores, and metadata, and stores this alert information in the alerts table. By structuring the decision logic in this way, the server improves consistency and reproducibility of risk evaluation, and makes it possible to achieve lower error rates compared to manual decision-making.

The server additionally uses the generative AI model to infer an emotional state of the user. The server extracts features indicative of emotion from the text content or from transcribed spoken content, such as sentiment polarity, intensity of language, and use of specific expressions. The server may include an auxiliary classifier head in the generative AI model architecture for emotion classification, trained via supervised learning on labeled emotional data. During inference, the server obtains an emotional state label, such as “calm,” “stressed,” or “angry,” with associated confidence values. The server then adjusts the output method of the alert information according to this emotional state and the determined security risk. For example, when the user is determined to be stressed, the server may choose a less intrusive visual notification on the terminal, whereas when the user is calm and the security risk is high, the server may send a more prominent notification or involve an administrator terminal. This conditional control of alert presentation is implemented in software that maps emotional state labels and risk levels to notification parameters such as display prominence, repetition interval, and required user acknowledgment. This yields a technical effect of reducing notification fatigue and increasing the likelihood that users will respond appropriately to high-risk alerts.

The terminal presents messages and alerts according to rendering instructions received from the server. The terminal executes a client application that displays messages in a graphical user interface. The terminal may render alert information as overlays, banners, or icons. The terminal may also output auditory notifications through speakers. The terminal exchanges user actions such as message input, acknowledgment of alerts, and view changes with the server via a standardized communication protocol. The server logs such interactions in the database for later analysis and system tuning. Because the server takes into account user emotion and dynamic risk evaluation, the terminal can exercise adaptive control over its display and audio subsystems, thus providing a user interface that is technically optimized for security-awareness without overwhelming the user.

The server achieves improvements in computer technology that go beyond automation of human review. The server reduces processing latency by using indexed database queries, in-memory caching of frequently accessed vectors, and batch calls to the generative AI model. The server improves accuracy by fusing model-based semantic analysis with structured similarity and anomaly computations. The server improves data management by structuring logs, scores, and alerts in normalized database tables with indexes, which allows efficient retrieval and machine analysis. The server reduces communication load by sending compact representations such as aggregated risk scores and summarized explanations to administrator terminals instead of raw message streams. These technical effects arise from the particular data structures, model architecture usage, and algorithmic combinations employed, rather than from a generic concept of “monitoring messages.”

In another embodiment, the server executes the generative AI model locally instead of via an external API. In this case, the server allocates graphics processing units or specialized accelerators to perform matrix multiplications of the transformer model. The server loads model parameters into device memory and uses optimized numerical libraries to speed up inference. The server may quantize model weights to reduced precision to decrease memory footprint and further reduce inference time. By configuring the model execution in this manner, the server can process a higher volume of messages in real time, which is critical for large organizations with high communication traffic.

In yet another embodiment, the server employs an ensemble of models, where a first model generates an initial risk assessment and a second model provides a refined evaluation focusing on policy-specific constraints. The server may apply a non-typical rule where, for messages involving external recipients and containing computed high similarity to prior confidential messages, the server overrides a low risk level produced by one model, thereby enforcing conservative behavior in specific high-stakes scenarios. These non-conventional combinations and overrides reflect system-level rules that are not simple restatements of human policy but rather structured, parameterized transformations of model outputs and scores tailored to the technological environment.

The server may implement additional variants of relevance and anomaly computation. For example, the server may maintain, in the storage device, a graph structure in which nodes represent topics derived from clustering of historical messages and edges represent transition probabilities between topics within conversation threads. The server can map a new message onto this graph and compute an anomaly score based on low probability transitions or rare topic combinations. Because the server operates on graph structures and probability distributions, the system can identify structurally anomalous communications that are not obvious from reading individual messages, thereby further improving detection performance.

The server may also implement alternative notification strategies as separate embodiments. In one embodiment, the server primarily notifies an administrator terminal and logs only minimal feedback to the user. In another embodiment, the server issues step-wise notifications, where an initial low-intensity notification appears on the user terminal, and, if the user repeats similar behavior within a time window, the notification escalates automatically. These embodiments illustrate that the system can be configured to control various devices and interfaces differently while still relying on the same core combination of generative AI model analysis and database-supported scoring.

By integrating these modules and data flows, the server provides a concrete, technical implementation that enables other practitioners to reproduce the invention. The server, the terminal, and the user cooperate in an architecture where the server performs complex numerical operations, model inference, and data management operations that are specifically structured to improve the speed, accuracy, and robustness of communication monitoring. The generative AI model and the associated algorithms are not used merely as a black box; instead, the server exploits specific structural properties of the model, controls how prompt sentences are generated, how outputs are parsed and combined with database metrics, and how alerts are presented, thereby achieving a technical improvement in computer-based communication security systems.

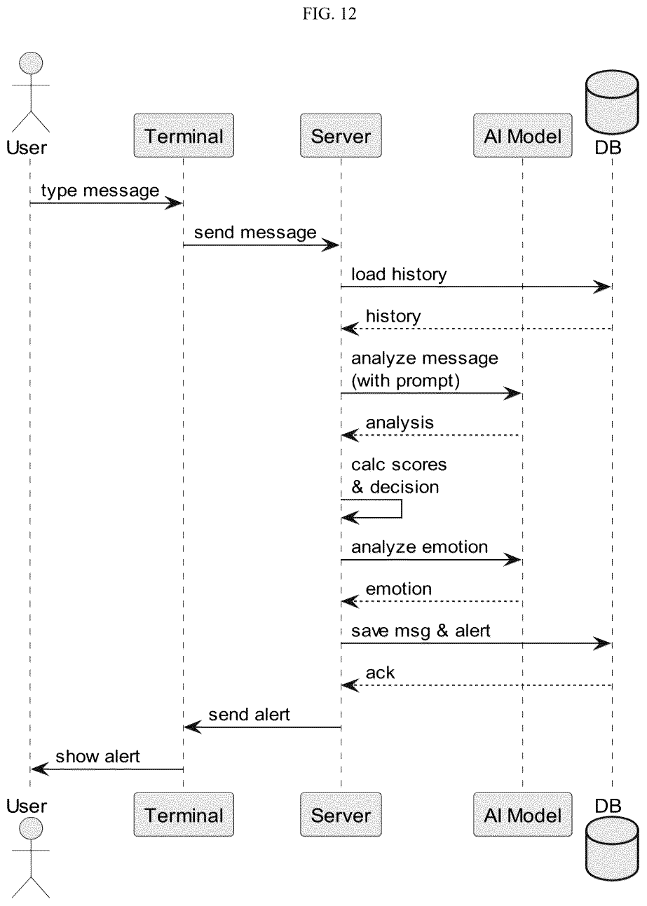

The following describes the processing flow using FIG. 12.

### Step 1

The user operates the terminal to open an in-house communication application and inputs a message into a text input field.

The terminal receives, as input, raw character data typed by the user and optional metadata such as channel identifier and recipient identifier.

The terminal converts the input into a structured data object including at least a message string, a user identifier, a timestamp, and channel information, and outputs this structured data object to the server via a network request.

### Step 2

The server receives, as input, the structured data object transmitted from the terminal through a communication interface.

The server parses the received data, verifies that required fields such as user identifier and message string are present, and validates formats such as timestamp and channel identifier.

The server outputs a normalized internal representation of the message, for example a message record containing sanitized text, associated user information, and a unique message identifier.

### Step 3

The server receives, as input, the normalized message record.

The server constructs a prompt sentence by combining a predefined instruction template with the message text and, optionally, additional context such as user role or channel type.

The server performs string concatenation and tokenization on the prompt sentence and the message text, and outputs a tokenized prompt sequence suitable for processing by the generative AI model.

### Step 4

The server receives, as input, the tokenized prompt sequence and model configuration parameters such as maximum output length and decoding temperature.

The server supplies the tokenized prompt to the generative AI model, which is implemented as a transformer-based neural network, and triggers inference.

The server controls numerical processing within the model, including matrix multiplications for attention and feed-forward layers, to compute probability distributions over output tokens, and outputs a generated analysis text representing the model's evaluation of risk and content.

### Step 5

The server receives, as input, the generated analysis text from the generative AI model.

The server applies text parsing operations, such as pattern matching and syntactic analysis, to extract structured elements including a risk level, an explanation, and detected sensitive terms.

The server outputs an analysis result object containing these structured fields in a machine-interpretable format.

### Step 6

The server receives, as input, the analysis result object and the original normalized message record.

The server accesses a storage device to retrieve past information, including historical message contents and previously computed feature vectors or scores, using query operations filtered by attributes such as user identifier or topic.

The server outputs a set of historical message records and associated feature representations for further comparison.

### Step 7

The server receives, as input, the current message text and the set of historical message texts.

The server converts each message into a numerical feature vector, for example by applying an embedding function or a text vectorization algorithm, and performs similarity computations such as cosine similarity between the current vector and each historical vector.

The server aggregates the similarity values and outputs a relevance score that represents how closely the current message is related to the stored historical messages.

### Step 8

The server receives, as input, the feature vector of the current message and a distribution of feature vectors representing normal historical communication patterns.

The server executes an anomaly detection computation, such as an isolation-based or clustering-based algorithm, to measure how far the current feature vector deviates from the normal distribution.

The server outputs an anomaly score that quantifies the degree of abnormality of the current message relative to past communications.

### Step 9

The server receives, as input, the relevance score, the anomaly score, and the AI-derived risk level included in the analysis result object.

The server performs numerical combination operations, such as weighted summation and threshold comparison, to calculate a combined risk score, and evaluates decision rules to determine whether the message exhibits low reliability or high security risk.

The server outputs a decision result object that includes at least a determination flag indicating normal or suspicious status, the combined risk score, and a reason code.

### Step 10

The server receives, as input, the original message text or transcribed spoken content and user-related contextual data.

The server generates a dedicated prompt sentence for emotion analysis and supplies it, together with the user content, to the generative AI model or an auxiliary classifier, and obtains emotion-related output values.

The server processes these values, for example by mapping probabilities to discrete emotional states such as calm or stressed, and outputs an emotional state descriptor associated with the user for the current message.

### Step 11

The server receives, as input, the decision result object and the emotional state descriptor.

The server determines notification parameters, such as notification medium, visual prominence, and repetition frequency, by applying mapping rules that depend on both the security risk and the emotional state.

The server constructs alert information including the message summary, risk explanation, and notification parameters, and outputs an alert object for delivery to one or more terminals.

### Step 12

The server receives, as input, the alert object.

The server records the alert in a database by inserting records into alert-related tables and linking them to the corresponding message and user entries, performing data write operations with transaction control to ensure consistency.

The server outputs a confirmation of successful storage and an updated state of the alert for subsequent retrieval and auditing.

### Step 13

The server receives, as input, the alert object and destination information such as administrator terminal identifiers and user terminal identifiers.

The server formats the alert into one or more notification messages suitable for different channels, such as visual messages for a client application and formatted text for an email subsystem, and transmits these messages over the network using appropriate communication protocols.

The server outputs network packets containing the alert information, thereby causing the terminals to receive and render notifications.

### Step 14

The terminal receives, as input, the notification message transmitted by the server.

The terminal decodes the message, interprets the notification parameters such as urgency level and display style, and configures its user interface components accordingly, for example by displaying a pop-up window or drawing a colored banner.

The terminal outputs the visual or auditory alert to the user and may further output user interaction data, such as acknowledgment or dismissal actions, back to the server for logging and future adjustment of system behavior.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information verification systems that attempt to assess the reliability of user-provided text, such as news articles or online posts, typically rely on simple keyword matching, rule-based filters, or static blacklists and whitelists stored in a data repository. Such systems are limited in their ability to understand natural language, to decompose complex narratives into discrete factual claims, and to correlate those claims with heterogeneous reliability information stored in large-scale data storage devices. As a result, these systems frequently generate inaccurate reliability assessments, either failing to detect unreliable information or over-flagging benign content, thereby degrading the usefulness of the verification process.

From a computer-technology standpoint, existing systems do not effectively exploit advanced natural language processing models in a structured, programmatic manner. In particular, existing systems do not systematically generate and manage prompt sentences tailored to the domain or format of input character information, do not normalize extracted claim information into structured forms suitable for high-precision database or vector search, and do not compute reliability indices using quantitative relevance scores combined with contextual metadata such as the number and temporal distribution of supporting records. This leads to inefficient utilization of computing resources in the server, suboptimal query formation for the data storage device, and reduced accuracy and robustness of reliability evaluation algorithms implemented in the processor.

Furthermore, existing systems generally provide warnings to users in a uniform manner, without considering a user's emotional state. Such uniform warnings can be excessively alarming or, conversely, too weak to be effective, depending on the user's condition and interaction context. From the perspective of human-computer interaction, this reduces the effectiveness of alert mechanisms and can degrade the overall usability and trustworthiness of the computing system.

Accordingly, there is a need for an improved computer-implemented technique that enables a processor in a server to (i) construct and supply domain-appropriate prompt sentences to a generative AI model, (ii) obtain and normalize structured claim information from user-provided character information, (iii) calculate relevance scores between the normalized claims and reliability information stored in a data storage device, (iv) compute and determine a reliability level of the character information based on such scores and contextual metadata, and (v) dynamically adjust content and output format of warning messages in response to an analyzed emotional state of the user. There is also a need for an improved communication process that continuously accepts user input and returns reliability levels and contextually adapted warnings in an iterative, interactive manner. Such improvements can enhance the technical functioning of the server, improve the precision and robustness of reliability evaluation, and provide more effective and adaptive user notifications.

The specific processing by the specific processing unit 290 of the data processing device 12 in Example 2 is realized by the following means.

The present invention provides a server comprising a processor configured to receive character information input from a user via an information terminal and generate a prompt sentence including the character information for instructing analysis by a generative AI model, input the prompt sentence to the generative AI model and, by natural language processing performed by the generative AI model, extract summary information and claim information from the character information, normalize the extracted claim information and generate, based on the normalized claim information, a search condition or a feature amount for acquiring reliability information stored in a data storage device, search the data storage device using the search condition or the feature amount and calculate a relevance score based on similarity or relatedness between the claim information and the reliability information, calculate a reliability index of the character information based on the relevance score and at least one of a number of items of the reliability information and time series information of the reliability information, determine a reliability level of the character information according to the reliability index, analyze an emotional state of the user and, when the reliability level is determined to be low, adjust content and an output format of a warning message according to the emotional state and output the warning message to the information terminal, perform a communication process for continuously accepting input from the user and sequentially returning the reliability level of the character information and the warning message to the information terminal, and select or generate the prompt sentence used as input to the generative AI model from a plurality of prompt sentence candidates according to a field type or a format type of the character information and generate the prompt sentence including a description that instructs a structured format of the claim information to be extracted. This enables the server to more effectively utilize the generative AI model and the data storage device to perform high-precision, context-aware reliability evaluation of user-provided character information, to improve the technical accuracy and robustness of reliability scoring algorithms within the processor, and to provide dynamically adapted warning messages that enhance user interaction and the overall performance of the computer-implemented verification system.

The term “system” refers to an arrangement of one or more computing devices and associated components configured to perform the processing steps described in the claims, including at least a server and optionally one or more information terminals and data storage devices.

The term “server” refers to an electronic apparatus including at least one processor and a memory, configured to provide computational services such as execution of programs, communication with an information terminal, interaction with a generative AI model, and access to a data storage device over a communication network.

The term “processor” refers to one or more hardware processing units, such as a central processing unit or a graphics processing unit, capable of executing instructions stored in a memory to perform logical operations, numerical computations, and control of data input, output, and storage.

The term “information terminal” refers to an electronic device operated by a user, such as a general-purpose computing device, a portable communication device, or a display device, that is capable of accepting character information from the user, communicating with the server, and presenting outputs including warning messages to the user.

The term “user” refers to a human operator or an entity that provides character information to the system, receives outputs from the system, and interacts with the information terminal during reliability evaluation processing.

The term “character information” refers to information expressed as a sequence of characters or symbols, including but not limited to text data representing news articles, posts, messages, or other natural-language content, which is input by the user and processed by the server.

The term “prompt sentence” refers to a textual instruction or set of instructions generated by the processor and supplied to a generative AI model, the textual instruction including at least a portion of the character information and specifying an analysis task such as extraction of summary information or claim information.

The term “generative AI model” refers to a machine-learned model configured to generate or transform text or other data based on input data, and including at least a natural language processing model such as a neural network model that performs operations including tokenization, contextual encoding, and text generation in response to a prompt sentence.

The term “natural language processing” refers to a set of computational techniques performed by the generative AI model or by other software modules to analyze and process human language texts, including operations such as tokenization, part-of-speech tagging, semantic analysis, summarization, information extraction, and claim identification.

The term “summary information” refers to information indicating a condensed representation of the main content or gist of the character information, generated by natural language processing so as to capture key points or topics in a reduced textual form.

The term “claim information” refers to one or more statements or propositions extracted from the character information that assert factual content or verifiable assertions, the statements being suitable for comparison with reliability information stored in a data storage device.

The term “normalize” refers to processing that converts extracted claim information into a standardized, consistent, and unambiguous representation, for example by removing redundancies, clarifying references, and unifying linguistic expressions so that the claim information is suitable for searching or matching against stored data.

The term “search condition” refers to a structured specification used by the processor to query the data storage device, including but not limited to keywords, logical constraints, filters, or other parameters derived from the normalized claim information.

The term “feature amount” refers to a numerical or vector representation of information derived from the normalized claim information, such as an embedding, a feature vector, or other machine-readable representation used for similarity computation or retrieval in the data storage device.

The term “data storage device” refers to one or more storage subsystems, such as a database system, a storage server, or a non-volatile memory device, configured to store reliability information and related metadata in association with identifiers, timestamps, or other attributes.

The term “reliability information” refers to information stored in the data storage device that is considered to have a known or predetermined trust level, such as verified records, reference documents, or fact-checked data, which is used as a basis for assessing the reliability of the claim information.

The term “relevance score” refers to a quantitative value calculated by the processor that represents a degree of similarity or relatedness between the claim information and the reliability information, the value being computable by, for example, similarity functions, distance measures, or statistical correlations.

The term “reliability index” refers to a composite quantitative measure calculated by the processor based on at least the relevance score and at least one of a number of items of the reliability information and time series information, the composite quantitative measure indicating an overall reliability of the character information.

The term “reliability level” refers to a classified or discrete indication of reliability of the character information, such as a categorical label (for example, high, medium, or low) or a tiered level, determined by the processor according to the reliability index.

The term “emotional state” refers to an estimated or inferred psychological condition of the user, such as levels of anxiety, confusion, confidence, or engagement, derived from user interaction data, input content, or other signals and used by the processor to adapt warning output.

The term “warning message” refers to information generated by the processor and provided to the information terminal to notify the user that the reliability level of the character information is low or otherwise requires attention, the information including text, symbols, or other content indicating caution or guidance.

The term “output format” refers to a mode or style in which the warning message is presented to the user by the information terminal, including at least one of a presentation modality, a visual layout, an auditory signal, a degree of emphasis, or an interaction pattern.

The term “communication process” refers to processing performed by the processor to exchange data with the information terminal over a communication path, including receiving character information from the user, transmitting reliability levels and warning messages, and maintaining an interactive session.

The term “field type” refers to a classification of the character information according to a subject area, domain, or topical category, such as health, finance, politics, or technology, which is used by the processor to select or generate an appropriate prompt sentence.

The term “format type” refers to a classification of the character information according to its structural or presentational format, such as a full-length article, a short message, a headline, or a question, which is used by the processor to tailor the structure and content of the prompt sentence.

The term “structured format of the claim information” refers to a predefined representation pattern for output of the claim information from the generative AI model, such as a numbered list, a key-value set, or a machine-readable schema, which is specified in the prompt sentence to facilitate downstream processing by the processor.

The term “related information” refers to information identified from the data storage device that is associated with the content or topic of the character information, such as background materials, explanatory records, or context documents, which can assist the user in understanding or evaluating the character information.

The term “alternative information” refers to information retrieved from the data storage device that presents different or corrective content compared to the character information, such as verified corrections, counter-claims, or authoritative explanations, which is presented to the user when the reliability level is low.

The term “reference information” refers to data included in the warning message that indicates how the user can access the related information or the alternative information, for example through identifiers, links, citations, or summaries, enabling the user to obtain further details from the data storage device or associated resources.

In one embodiment, a server, an information terminal, and a data storage device cooperate to implement the invention. The server includes at least one processor and a memory, and executes a program that causes the processor to generate a prompt sentence, to interact with a generative AI model, to compute reliability indices, and to control output of warning messages. The information terminal includes an input unit, a display unit, and a communication interface, and the data storage device includes a structured storage of reliability information.

The server operates on general-purpose hardware, such as a computing platform including a central processing unit, a graphics processing unit, a main memory, and a non-volatile storage device. The server executes an operating system and a middleware stack such as a web server and an application framework. In one implementation, the server uses a relational database management system or a search engine for the data storage device. The server communicates with the information terminal over a packet-based communication network using a transport protocol.

The terminal operates as an interface device between the user and the server. The terminal presents an input screen that includes a text field and control elements for submitting character information. The terminal converts the user's keystrokes or touch actions into encoded character data, maintains local buffers of the entered text, and transmits the character information to the server using a structured message format. The terminal also receives a reliability level and a warning message from the server and renders them on the display unit, optionally combined with visual emphasis or audible indicators according to control data received from the server.

The user operates the terminal to input character information, such as a news article or a textual claim, and to request an assessment of the reliability of the information. The user may repeatedly modify or extend the character information and may request multiple assessments in an interactive session. The user also perceives the terminal output and may adjust behavior or decisions based on the reliability level and the warning message.

The server stores and executes a program that implements multiple functional modules in memory. The server maintains a communication module, a prompt generation module, a natural language analysis module, a claim normalization module, a search and similarity computation module, a reliability computation module, an emotional state analysis module, and a warning control module. Each module is realized as software routines that read and update data structures stored in the memory and the data storage device.

The server uses a generative AI model configured as a neural network for natural language processing. In one embodiment, the generative AI model includes an embedding layer, a stack of transformer layers, and an output layer. The embedding layer converts input tokens into continuous vectors. Each transformer layer includes a self-attention mechanism and a feed-forward subnetwork, with trainable weight parameters. The output layer generates token probability distributions used to produce text outputs. The generative AI model is trained in advance using a large corpus of natural language data by minimizing a loss function such as cross-entropy between predicted tokens and reference tokens, using gradient-based optimization and weight updates. The server stores the trained weight parameters in a model storage area and loads them into memory for inference.

The server constructs a prompt sentence to control specific operations of the generative AI model. The server stores multiple prompt templates in memory, each template associated with a field type and a format type. The server determines a field type and a format type of the character information based on heuristics, such as keyword distributions, length, sentence structure, and metadata from the terminal. The server selects a prompt template whose associated attributes best match the detected field type and format type. The server then inserts the character information into a placeholder region of the selected prompt template to generate a concrete prompt sentence.

In one example, the server generates the following prompt sentence:

“Analyze the following news article. Extract the main keywords, named entities (persons, organizations, locations), and summarize the context in 2-3 sentences. Then list all key factual claims as a numbered list.

Article:

A new virus has been discovered that spreads faster than a previously known disease and is reported in several regions.”

In another example, the server generates the following prompt sentence for claim normalization:

“Given the following claims extracted from a news article, rewrite each claim in a concise and unambiguous form suitable for database matching. Keep one claim per line.

Claims:
1. A new virus has been discovered that spreads faster than a previously known disease.
2. The virus is already present in ten countries.”

The server supplies the prompt sentence, as a continuous text string, to the generative AI model. The server tokenizes the prompt sentence, assigns token identifiers based on a predetermined vocabulary, and converts the token identifiers into embedding vectors. The server then applies the transformer layers to the sequence of embedded tokens. Each transformer layer computes attention weights between tokens to capture long-range dependencies and contextual relationships, and applies feed-forward transformations to encode semantic features. The output layer converts the final hidden states into token-level outputs. The server decodes the generated tokens to obtain textual analysis results.

The server interprets the output of the generative AI model as structured information. The server uses pattern-based parsing, for example recognizing numbered lists and section markers, to separate the output into components such as summary information and claim information. The server stores the summary information and the claim information in a structured data object, such as a record including fields for tokens, sentence boundaries, and semantic tags. The server may additionally compute numerical feature amounts for each claim, such as sentence length, presence of temporal expressions, and presence of named entities.

The server normalizes the claim information using algorithmic rules that go beyond simple human manual rewriting. The server applies linguistic normalization procedures, such as converting all verbs to a base form, replacing pronouns with resolved antecedents based on coreference analysis, and mapping synonymous terms to canonical labels using a domain lexicon. The server also removes redundant modifiers and harmonizes numerical expressions to standardized units. These operations produce normalized claim strings that are more suitable for consistent retrieval and similarity computation than raw human-entered text.

The server generates search conditions and feature amounts for each normalized claim. The server derives keyword sets from the normalized claim by selecting content words and named entities using part-of-speech tagging and named entity recognition. The server generates a keyword-based search condition, such as a conjunction of tokens and optionally a time constraint. In addition, the server computes a vector representation (feature amount) of each normalized claim using a sentence embedding model. That model may be a neural network that maps sequences of word embeddings into a vector in a high-dimensional space, trained with a contrastive or triplet loss to bring semantically similar sentences closer in the embedding space. The server stores these feature amounts for use in similarity calculations.

The server accesses the data storage device to retrieve reliability information. The data storage device stores a plurality of records, each record including content text, source attributes, timestamps, and precomputed embeddings. The server executes search operations defined by the search conditions and feature amounts. The server may perform keyword-based retrieval to obtain candidate records and then use the vector feature amounts to compute cosine similarity or another distance measure between the normalized claim and each candidate record. The server aggregates similarity values and determines a relevance score for each claim based on, for example, a maximum similarity, an average of top-k similarities, or a weighted sum that considers both similarity and source trust level.

The server computes a reliability index for the character information from the relevance scores and contextual metadata. The server considers, for each claim, the relevance score, the count of supporting records with similarity above a threshold, and the temporal distribution of those records. The server may define a function that increases the reliability index when multiple independent records confirm a claim and when the records are recent, and decreases the index when no such records exist or when records conflict with the claim. The server sums or otherwise combines the claim-level measures to produce a document-level reliability index. The server then maps the reliability index to a discrete reliability level such as “high,” “medium,” or “low” based on predetermined threshold values. These calculations exploit structured numerical features and are not a mere restatement of human intuition; they are designed to optimize discrimination between reliable and unreliable texts in a quantifiable manner.

The server analyzes the emotional state of the user using technical signals. The server may use text-based emotion inference by applying a separate neural network model to recent user inputs and interactions. This model may be a classifier that receives character sequences or embeddings and outputs probabilities for emotional categories. The classifier may be trained with supervised learning, using labeled data of text and associated emotional states, optimized by minimizing a classification loss function. The server can also incorporate interaction parameters such as input speed and repetition frequency to refine the emotional state estimation. The server stores the estimated emotional state as a categorical or continuous variable.

The server uses the estimated emotional state to control the warning message. When the reliability level is low, the server selects a warning pattern that adjusts message length, tone, and output format. For example, when the emotional state indicates high anxiety, the server may shorten the message and avoid overly alarming wording, and may emphasize links to explanatory related information. When the emotional state indicates low engagement, the server may provide a more detailed explanation and highlight the warning with stronger visual emphasis. The server encodes these control decisions in a warning message structure and transmits the structure to the terminal. The terminal then interprets and renders the warning in accordance with a predefined mapping from control fields to user interface behaviors.

The server also identifies related information and alternative information for assisting the user. The server selects records from the data storage device that are most similar to the character information or that provide corrected or authoritative descriptions. The server generates reference information, such as identifiers or brief summaries, and includes such reference information in the warning message. This allows the terminal to display links or pointers that guide the user to further technical content rather than only presenting an abstract caution.

The server performs these computations in an iterative communication process. The server keeps track of a session with the terminal, accumulates analysis results for multiple user inputs, and re-uses previously computed embeddings and reliability indices to avoid redundant computation. The server can cache recently used feature amounts and similarity results in memory and bypass re-computation when the same or similar character information is analyzed. This improves processing speed and reduces computational load. By structuring data in intermediate representations (normalized claims, embeddings, indices), the server improves data management and enables incremental updates to the reliability evaluation while the user is still editing the text.

The described structure produces technical effects that extend beyond mere automation of human judgment. The server uses a specific combination of embedding-based similarity computation, normalized claim representation, and threshold-based reliability computation to achieve higher precision and reproducibility than ad hoc human review. Because the server encodes text into a structured numeric form and computes relevance scores in a high-dimensional space, the system can rapidly evaluate large volumes of character information in a time shorter than would be possible with human analysis, while maintaining consistent criteria. The use of precomputed embeddings in the data storage device and the reuse of feature amounts reduces the number of costly model inferences and database traversals, thus improving throughput and reducing communication and storage access overhead.

The generative AI model and related neural network components also embody specific technical design choices. The models are trained using large-scale data augmentation techniques, such as randomly masking tokens and shuffling sentence order, to make the embeddings robust to paraphrases and minor textual variations. The training process uses mini-batch gradient descent and employs regularization methods such as dropout to prevent overfitting. The loss functions are selected to optimize the separation of semantically distinct claims in the embedding space. These details ensure that the numerical representations used for similarity calculations are technically effective and provide a foundation for the reliability index computation.

The server uses algorithmic rules that differ from standard rule-based filtering or human procedures. For example, instead of checking simple keyword overlaps or fixed blacklists, the server operates on normalized claims and numerical distances, and dynamically adapts thresholds based on source trust levels and temporal decay functions. This non-conventional combination of generative text analysis, structured normalization, and vector-space retrieval modifies the way the computing system manages and evaluates textual data, leading to quantifiable improvements in both detection accuracy and computational efficiency.

Alternative embodiments are also possible. The server may use different neural network architectures for the generative AI model, such as recurrent networks or convolutional networks, provided that the model supports context-sensitive decoding of prompt sentences and extraction of structured information. The server may use alternative similarity measures, such as Manhattan distance or kernel-based metrics, and may implement the data storage device as a distributed key-value store or a graph database instead of a relational database. The terminal may be realized as a desktop device, a wearable device, or an in-vehicle display, and may output warnings not only on a display but also through vibration or other actuators. The emotional state analysis may incorporate physiological signals obtained through sensors connected to the terminal, further improving the adaptation of warnings.

By structuring data in a set of well-defined representations, using neural network-based feature extraction and similarity computation, and coupling these elements with interactive communication and adaptive warning control, the server improves the internal functioning of the computer system itself. The system reduces unnecessary data transfer and repeated computation, maintains consistent and explainable reliability indices, and delivers technically improved human-machine interaction that cannot be achieved by manual review or by naive automation of human processes.

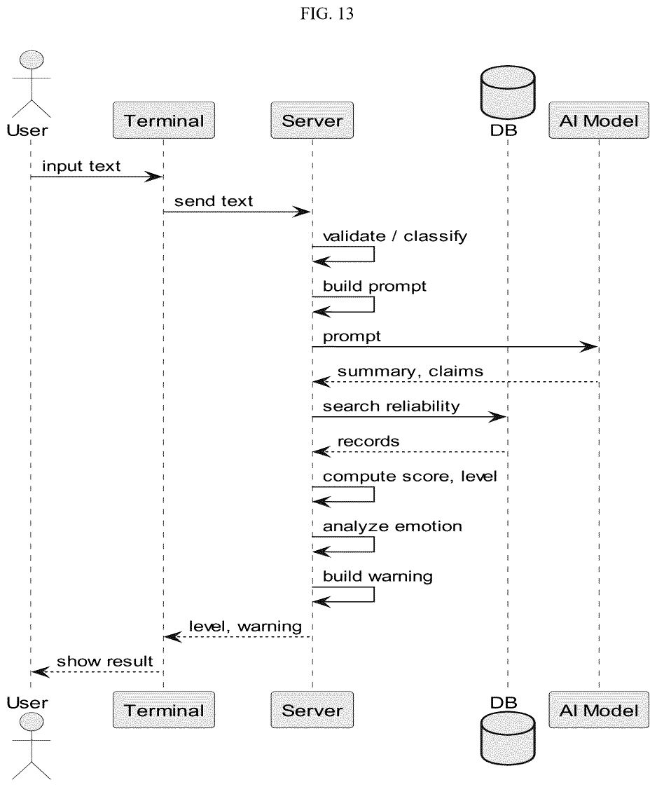

The following describes the processing flow using FIG. 13.

### Step 1

The user operates the terminal to input character information.

The user enters text, such as a news article or a claim, into an input field displayed on the terminal and operates a control element to request reliability evaluation. The terminal receives the keystrokes or touch events, converts them into a character string encoded in a predetermined character code, and stores the character string in a local buffer.

Input: Raw user keystrokes or touch inputs.

Output: Encoded character information stored as a text string in the terminal's memory.

### Step 2

The terminal transmits the character information to the server.

The terminal packages the character string into a structured message, appends session identifiers and metadata such as language or content length, and establishes a network connection to the server using a communication protocol. The terminal then sends the message to a predefined endpoint on the server.

Input: Encoded character information and metadata in the terminal.

Output: A network request containing the character information and metadata delivered to the server.

### Step 3

The server receives and validates the character information.

The server accepts the network request, parses the message structure, and extracts the character information and associated metadata. The server checks that the character information is non-empty, that its length is within allowed bounds, and that the encoding is valid. If necessary, the server normalizes line breaks and removes invalid characters.

Input: Network message containing character information and metadata.

Output: Validated and normalized character information stored in the server's memory, or an error response if validation fails.

### Step 4

The server determines a field type and a format type of the character information.

The server analyzes the content using keyword statistics, length, sentence count, and presence of specific markers to classify the character information into a field type such as health, finance, or politics, and a format type such as full article, short message, headline, or question. The server may compute simple numerical features, such as word frequency vectors, and compare them against threshold rules to assign these types.

Input: Validated character information.

Output: Field type and format type labels associated with the character information.

### Step 5

The server generates a prompt sentence for a generative AI model.

The server selects a prompt template corresponding to the determined field type and format type from a stored set of templates. The server inserts the character information into a placeholder region of the selected template to construct a complete prompt sentence that instructs the generative AI model to perform tasks such as summarization and claim extraction.

Input: Character information, field type, and format type.

Output: A constructed prompt sentence in text form, ready for input to the generative AI model.

### Step 6

The server inputs the prompt sentence to the generative AI model and obtains analysis results.

The server tokenizes the prompt sentence according to the generative AI model's vocabulary, converts the tokens into numerical identifiers, and forwards the identifiers to the generative AI model. The generative AI model applies its embedding layer and a sequence of transformer layers to compute contextual representations, then generates output tokens that represent a summary, keywords, and claim information. The server decodes the output tokens into text and segments the text into structured elements such as summary paragraphs and numbered claim lines.

Input: Prompt sentence as a text string.

Output: Structured analysis results including summary information and raw claim information.

### Step 7

The server normalizes the extracted claim information.

The server processes each claim using linguistic rules and models. The server performs tokenization and part-of-speech tagging, replaces pronouns with resolved references, converts verbs to base forms, and maps synonyms to canonical terms using a domain lexicon. The server also standardizes numerical expressions and removes unnecessary modifiers. These operations produce normalized claim strings that are more consistent and suitable for search and matching.

Input: Raw claim information extracted from the generative AI model output.

Output: A list of normalized claim strings and associated linguistic feature data.

### Step 8

The server generates search conditions and feature amounts for the normalized claims.

The server selects important words and named entities from each normalized claim using part-of-speech tags and entity labels, and constructs keyword-based search conditions. The server also encodes each normalized claim into a numerical feature vector using a sentence embedding model. The server stores, for each claim, the set of keywords and the feature vector as retrieval parameters.

Input: Normalized claim strings and linguistic feature data.

Output: For each claim, a keyword-based search condition and a numerical feature amount (embedding vector).

### Step 9

The server retrieves reliability information from a data storage device.

The server sends the keyword-based search conditions to the data storage device and requests candidate records that match the conditions. The data storage device returns records that satisfy the conditions, along with their stored content, timestamps, and precomputed embeddings. The server receives and buffers these candidate records for subsequent computation.

Input: Keyword-based search conditions for each normalized claim.

Output: Sets of candidate reliability records and associated metadata for each claim.

### Step 10

The server computes relevance scores between the claims and the reliability information.

The server calculates similarity values between each claim's feature vector and the embedding vectors of the candidate records using a similarity measure such as cosine similarity. The server aggregates these similarity values, for example by taking the maximum similarity or averaging the top-k values, and incorporates source trust levels if available. The server thus computes a relevance score for each normalized claim that quantifies how closely the claim matches the stored reliability information.

Input: Claim feature vectors and embeddings of candidate reliability records.

Output: A relevance score for each normalized claim.

### Step 11

The server calculates a reliability index and determines a reliability level for the character information.

The server combines the relevance scores across all claims using a weighting function that may consider the number of supporting records and their timestamps. The server computes a reliability index as a numerical value representing overall reliability. The server compares the reliability index against predetermined threshold values to determine a reliability level such as high, medium, or low.

Input: Relevance scores and metadata such as record counts and timestamps.

Output: A numerical reliability index and a discrete reliability level for the character information.

### Step 12

The server analyzes an emotional state of the user.

The server processes recent user inputs, such as the text content and interaction patterns (for example, frequency of requests or rapid resubmissions), using an emotion classification model or rule set. The server converts these observations into features and applies the classifier to estimate emotional categories or scores, such as anxiety level or engagement level.

Input: User text history and interaction pattern data received from the terminal.

Output: An estimated emotional state value or category associated with the user.

### Step 13

The server generates and adjusts a warning message according to the reliability level and the emotional state.

The server checks whether the reliability level is below a warning threshold. When the reliability level is low, the server composes a warning message text that explains the low reliability and may list unsupported claims. The server then adjusts the message style and output parameters based on the emotional state, for example selecting a shorter or longer explanation and modifying the strength of cautionary language. The server also inserts reference information pointing to related or alternative information obtained from the data storage device.

Input: Reliability level, reliability index, normalized claims, relevance scores, and emotional state.

Output: A composed warning message with adjusted content and control parameters for presentation.

### Step 14

The server transmits the reliability results and the warning message to the terminal.

The server packages the reliability level, reliability index, and warning message, together with any reference information, into a response message. The server sends this message to the terminal over the communication network and updates any session state associated with the user.

Input: Reliability evaluation results and formatted warning message.

Output: A network response containing reliability information and warning data delivered to the terminal.

### Step 15

The terminal presents the reliability level and the warning message to the user.

The terminal receives the response from the server, parses the message, and extracts the reliability level, reliability index, warning text, and control parameters. The terminal selects an output format, such as a dialog, banner, or notification, based on the control parameters and renders the warning text on the display. The terminal may also generate sound or vibration according to the specified output format, thereby informing the user of the reliability status.

Input: Response message from the server including reliability and warning data.

Output: Visual and optional auditory output on the terminal that presents the reliability level and warning message to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional fact-checking and misinformation mitigation systems typically rely on static rules or simple machine learning classifiers that operate on fixed text features. Such systems suffer from several technical limitations. First, they generally cannot consume long, heterogeneous user inputs in a robust manner: differences in formatting, character encoding, and extraneous content (such as boilerplate or markup) often degrade model performance and require manual pre-processing logic that is fragile and difficult to scale. Second, existing systems that invoke a generative AI model usually pass user text directly to the model without a structured prompt sentence or without requesting machine-readable reliability signals, which leads to free-form outputs that are hard for a computer to parse and aggregate with other signals. As a result, it is technically difficult for a computing system to consistently derive a numerical reliability score, to correlate that score with reference data, or to perform downstream automated control based on such a score.

Third, conventional architectures do not integrate embedding-based similarity computation with the generative AI model's own internal assessment in a unified scoring pipeline. Embedding models are often used separately from generative models, and there is no coordinated mechanism in the computer system to compute and combine a model-generated reliability score, an embedding-based relatedness score, and rule-based evaluation values. This separation results in inefficient data flow, duplicated computations, and non-deterministic decision logic that complicates implementation and maintenance.

Fourth, existing systems rarely leverage user emotion state as a first-class input to the computational pipeline. In many architectures, user interface adaptation (for example, changing colors or sounds) is manually designed and decoupled from the core analysis. There is no systematic mechanism for the processor to estimate user emotion from multimodal data (image, audio, and operation signals) and to use the estimated emotion to change analysis precision, select between models, or dynamically reconfigure prompt sentences. Consequently, the computing system cannot allocate computational resources adaptively, cannot tune generative AI model behavior to the user's state, and cannot automatically optimize warning presentation for different emotional conditions.

Fifth, many systems do not support low-latency, real-time reliability evaluation while the user is actively viewing information. Network latency, heavy model calls, and ad-hoc pre/post-processing pipelines often produce delays that make interactive use impractical. Moreover, the response data structures are not designed to carry, in a single transaction, a complete set of reliability metrics and presentation control information, so client-side software must infer or reconstruct missing parameters, increasing complexity and error risk.

Accordingly, there is a need for a computer-implemented system that improves the underlying computer technology for reliability evaluation and warning presentation. Specifically, there is a need for a processor-controlled architecture that (i) normalizes and truncates user-provided information into analysis-ready input, (ii) systematically constructs and manages a structured prompt sentence for a generative AI model, (iii) extracts and combines numerical reliability signals from both model output and embedding-based similarity against reference information, (iv) estimates user emotion state from multimodal terminal data and uses that state to control model selection, analysis precision, and prompt configuration, and (v) generates structured response data that includes both reliability indicators and fine-grained presentation control parameters, enabling low-latency, adaptive, and machine-controlled user warnings. By solving these issues, the invention aims to enhance the technical performance, robustness, and adaptability of computer systems that evaluate information reliability and present warnings to users.

The specific processing by the specific processing unit 290 of the data processing device 12 in Application Example 2 is realized by the following means.

The present invention provides a server comprising a processor configured to receive information from a user terminal and generate analysis target information by normalizing the received information, formatting characters and white spaces, and truncating the received information to a predetermined length to provide input suitable for a generative AI model; to generate a structured prompt sentence by inserting the analysis target information into a predetermined template that instructs the generative AI model to output at least a reliability score, explanation information, and main-claim information; to input the prompt sentence to the generative AI model, to parse an output of the generative AI model, and to extract from the output the reliability score, the explanation information, and the main-claim information as an analysis result; to generate feature data by calculating vector representations of at least one of the analysis target information and the main-claim information using at least one of the generative AI model and an embedding model, and to calculate a relatedness score based on a similarity between the feature data and feature data of reference information stored in a storage device; to calculate a final reliability score of the analysis target information by combining the reliability score, the relatedness score, and a rule-based evaluation value with predetermined weightings, and to determine a reliability level of the analysis target information by comparing the final reliability score with a threshold value; to generate, when the reliability level is determined to be low or within a predetermined range, a warning message using the explanation information and to construct structured response data including the warning message, the final reliability score, and the reliability level; to estimate an emotional state of a user and an intensity of the emotional state by performing emotion analysis processing based on at least one of image information, audio information, and operation information acquired from the user terminal; to adjust an analysis precision by changing at least one of a type of the generative AI model to be used, a number of generated tokens, and an analysis detail level to switch an analysis mode, or by modifying an instruction content in the prompt sentence, in accordance with the emotional state and a type of the analysis target information; and to determine presentation control information indicating at least one of a display color, a display size, presence or absence of an icon, and presence, absence, or volume of an alert sound for the warning message based on the emotional state and the reliability level, and to transmit the structured response data together with the presentation control information to the user terminal. This enables the computer system to perform low-latency, end-to-end reliability evaluation and adaptive warning presentation, to systematically integrate generative AI output with embedding-based similarity computation in a unified scoring pipeline, to dynamically adjust model behavior and computational resources based on user emotion state and content type, and to deliver machine-readable response data that allows a client device to render consistent, context-aware visual and auditory warnings without additional complex processing.

The term “system” refers to an arrangement of one or more computing devices and one or more user terminals that cooperate via a communication network to perform information analysis, reliability evaluation, and warning presentation.

The term “server” refers to an information processing apparatus including at least one processor, a memory, and a communication interface, configured to receive data from a user terminal, execute software components, call machine learning models, access a storage device, and return response data.

The term “processor” refers to one or more hardware processing units, such as a central processing unit or a specialized computing device, that execute computer-readable instructions to perform the operations described in the claims.

The term “user terminal” refers to a client-side computing device operated by a user, such as a portable communication device, a personal computing device, or another interactive device, that is configured to capture user input, present outputs, and communicate with the server.

The term “information” refers to digital content provided by the user terminal, including at least text data such as an article, a message, or a statement, and optionally an identifier such as a resource locator or metadata associated with the content.

The term “analysis target information” refers to a version of the received information that has been normalized, formatted, and optionally truncated, and that is prepared as input data suitable for processing by a generative AI model.

The term “normalizing” refers to processing operations that convert the received information into a standardized representation, including at least unifying character encodings, adjusting character types, removing unnecessary markup, and organizing white spaces.

The term “generative AI model” refers to a machine learning model configured to process input data and generate text or other outputs, capable of understanding natural language content and producing responses such as evaluations, explanations, and extracted elements.

The term “prompt sentence” refers to a structured textual instruction provided to the generative AI model, which includes at least part of the analysis target information and directives that specify how the generative AI model should process the information and what format of output is requested.

The term “template” refers to a predefined textual structure used to construct the prompt sentence, including fixed instruction portions and placeholders into which the analysis target information is inserted.

The term “reliability score” refers to a numerical indicator, such as a value within a predetermined range, generated or derived by the system to represent an estimated degree of trustworthiness or correctness of the analysis target information.

The term “explanation information” refers to textual or structured data that provides reasons, grounds, or analysis supporting a reliability evaluation produced by the generative AI model or derived from the model output.

The term “main-claim information” refers to data representing one or more principal assertions, statements, or propositions identified within the analysis target information by the generative AI model or another analysis process.

The term “analysis result” refers to a set of data extracted from the output of the generative AI model, including at least the reliability score, the explanation information, and the main-claim information.

The term “feature data” refers to numerical representations, such as vector data or embeddings, that encode semantic or statistical characteristics of the analysis target information or the main-claim information.

The term “embedding model” refers to a machine learning model configured to transform input text or other content into feature data in the form of one or more numerical vectors that capture semantic similarity relationships.

The term “reference information” refers to information stored in a storage device that is used as a basis for comparison, including at least previously collected or verified data related to the subject matter of the analysis target information.

The term “storage device” refers to a logical or physical data storage component, such as a database system or a persistent memory device, that stores reference information, feature data, analysis logs, or other records used by the server.

The term “relatedness score” refers to a numerical measure of similarity or correlation between feature data derived from the analysis target information and feature data associated with the reference information.

The term “rule-based evaluation value” refers to a numerical or categorical value obtained by applying predetermined logical rules or heuristic criteria to the analysis target information, the analysis result, or related metadata.

The term “final reliability score” refers to a computed value that results from combining, according to predetermined weightings, at least the reliability score, the relatedness score, and the rule-based evaluation value, and that is used to assess the reliability of the analysis target information.

The term “reliability level” refers to a classification of reliability, such as low, medium, or high, determined by comparing the final reliability score with at least one threshold value.

The term “warning message” refers to information generated for presentation to a user, indicating that the reliability level of the analysis target information satisfies a predefined condition, such as being low or within a cautionary range.

The term “structured response data” refers to a data structure, such as a record or message, that includes at least the warning message, the final reliability score, the reliability level, and optionally additional parameters used for presentation control.

The term “image information” refers to visual data obtained from an image sensor of the user terminal, such as still images or video frames that can be used for emotion analysis.

The term “audio information” refers to sound data obtained from an audio sensor of the user terminal, such as speech signals or other acoustic signals that can be used for emotion analysis.

The term “operation information” refers to data representing user interaction with the user terminal, including at least key input patterns, pointing device actions, touch gestures, or other interaction metrics.

The term “emotion analysis processing” refers to computational operations that analyze at least one of image information, audio information, and operation information to estimate an emotional state and an intensity of the emotional state of the user.

The term “emotional state” refers to an inferred psychological or affective condition of the user, such as calm, excited, confused, angry, or stressed, determined by the emotion analysis processing.

The term “analysis precision” refers to a level of detail, thoroughness, or resource allocation applied to the analysis of the analysis target information, including selection of model type, length of generated output, and granularity of reasoning.

The term “analysis mode” refers to a configuration of the system that specifies at least one of a selected generative AI model, model parameters, and processing depth that is applied when analyzing the analysis target information.

The term “instruction content” refers to textual directives included in the prompt sentence that specify how the generative AI model should perform analysis, what outputs are required, or what evaluation criteria to apply.

The term “presentation control information” refers to data indicating parameters for displaying or outputting the warning message, including at least a display color, a display size, a presence or absence of an icon, and a presence, absence, or volume of an alert sound.

The term “alert sound” refers to an acoustic output produced by a sound generator of the user terminal to draw the user's attention to the warning message.

The term “encrypted communication channel” refers to a communication path established between the user terminal and the server that uses cryptographic protocols to protect data confidentiality and integrity during transmission.

The term “real time” refers to a manner of processing in which the server performs reliability evaluation and returns structured response data with a latency that allows the user terminal to present updated warnings or scores while the user is viewing or interacting with the corresponding information.

In one embodiment, a server controls the overall information reliability evaluation and warning presentation. The server includes at least one processor, a main memory, a non-transitory storage device, and a network interface. The server executes an operating system such as a general-purpose server operating system and runs an application layer implemented, for example, in a high-level programming language with a web framework. The server communicates with one or more terminals over a communication network using a secure protocol.

A terminal operates as a client device. The terminal is, for example, a portable communication device or a personal computing device including a central processor, a memory, a display, an audio output device, a camera, a microphone, an input device such as a keyboard or a touch panel, and a communication interface. The terminal executes a browser or a dedicated application that sends user-provided information to the server, receives reliability evaluation results and presentation control parameters, and renders visual or auditory warnings according to those parameters.

A user interacts with the terminal by inputting text information or by viewing digital content such as news articles or messages. The user causes the terminal to send the text information, or an identifier of the text information, to the server through the network interface.

The server stores computer-readable instructions that implement an information reliability evaluation module. The server uses these instructions to perform normalization, prompt sentence generation, generative AI model invocation, feature extraction, relatedness computation, score combination, emotion analysis, adaptive analysis control, and structured response generation.

The server uses a storage device, such as a relational database system, to store reference information, feature data, user requests, generative AI model outputs, and emotion-related records. The server organizes records in tables that include fields for a request identifier, normalized text, prompt sentence, model output text, reliability score, relatedness score, rule-based score, final reliability score, reliability level, and presentation control information. The server maintains indexes on at least the feature data and reference information metadata to accelerate similarity queries.

The server employs a generative AI model as a neural network implemented either on the same server or on a remote computing resource. In one example, the generative AI model is a transformer-based neural network with multiple self-attention layers, feedforward layers, and layer normalization. The generative AI model is trained on large-scale natural language corpora using an autoregressive objective that minimizes a cross-entropy loss between predicted tokens and ground truth tokens. The server stores trained model parameters such as weight matrices, bias vectors, and normalization parameters in a dedicated model storage. The server also maintains an embedding model that converts text sequences into fixed-dimensional real-valued vectors by aggregating token embeddings or by using a dedicated embedding network.

The server trains the generative AI model and the embedding model in advance. The server uses training data that includes pairs of text and annotated signals, such as reliability-related labels, factuality indicators, and domain-specific categories. The server performs gradient-based optimization, such as stochastic gradient descent or variants with adaptive learning rates, to update model parameters. The server defines a loss function that combines next-token prediction loss with an auxiliary loss related to reliability classification. The server may apply data augmentation techniques, such as paraphrase generation and synonym replacement, to expand the training corpus and improve robustness to variations in input text. The server may fine-tune the generative AI model on reliability-focused datasets to bias its outputs towards careful and conservative assessments.

The server uses a prompt sentence mechanism to control the behavior of the generative AI model at inference time. The server stores one or more prompt sentence templates in a configuration storage. Each template contains fixed instruction text and placeholders for inserting analysis target information and optional parameters. For example, the server can use the following prompt sentence:

“You are a fact-checking assistant. Evaluate the reliability of the following information.

Provide: (1) a reliability score from 0 to 100, (2) a brief explanation, and (3) the main claims that should be checked.

Text: “‘[ANALYSIS_TARGET_INFORMATION]’””

The server replaces the placeholder [ANALYSIS_TARGET_INFORMATION] with normalized text derived from user input. In another example, when the server focuses on medical content, the server can use the following prompt sentence:

“Evaluate the reliability of the following medical claim. Provide a reliability score from 0 (unreliable) to 100 (highly reliable) and a brief explanation focusing on medical plausibility and existing scientific evidence.

Text: ‘[ANALYSIS_TARGET_INFORMATION]’”

The server may further adjust the instruction portion of the prompt sentence depending on user emotion or content type. For example, when the user appears excited or stressed, the server modifies the instruction to require a stricter evaluation:

“Use cautious and conservative judgment. If the evidence is unclear or conflicting, lower the reliability score and highlight uncertainties.”

The server normalizes user-provided information before constructing the prompt sentence. The server receives raw text or an identifier such as a uniform resource locator from the terminal. When the server receives an identifier, the server retrieves corresponding content from a content source using an HTTP client. The server strips markup tags, scripts, style elements, and advertisements from the retrieved content and extracts main text portions such as titles, headings, and body paragraphs. The server unifies character encodings (for example, to UTF-8), converts full-width characters to half-width characters where appropriate, normalizes line breaks and white spaces, and removes repeated punctuation used only for emphasis. The server detects the language of the text using a language detection algorithm such as a character-ngrams classifier and may apply language-specific normalization such as lowercasing or script normalization.

The server truncates the normalized text to a predetermined length expressed in tokens or characters that matches the input constraints of the generative AI model. The server applies a tokenization algorithm compatible with the model, such as byte-pair encoding or sentencepiece, to estimate the token count and selects the most informative portions of the text, such as the title, the first paragraphs, and the conclusion. The server thereby creates analysis target information that is guaranteed to be accepted by the model without overflow, which improves processing reliability and avoids runtime errors that may occur when raw text exceeds model input limits.

The server generates feature data for both the analysis target information and reference information. The server applies an embedding model to convert text into numerical vectors in a high-dimensional space. The embedding model may be a transformer-based encoder that outputs a vector representation for each input text, for example, using the hidden state of a special classification token. The server stores reference feature vectors in the storage device. When new analysis target information arrives, the server computes its feature vector and performs similarity search against stored vectors using a similarity measure such as cosine similarity. The server can implement this similarity search using optimized linear algebra libraries or approximate nearest neighbor structures, such as tree-based or hash-based indexes, to reduce computation time compared to naive pairwise comparison.

The server computes a relatedness score based on the similarity between the feature vector of the analysis target information and one or more feature vectors of reference information. The server may compute an aggregate similarity value by taking a weighted average of the top-k similarity scores or by applying a function that reflects both similarity magnitude and the reliability of the reference records. The server thereby quantifies how closely the new information aligns with previously stored and vetted information.

The server also executes rule-based evaluation logic to complement the model-based scores. The server defines rules that detect certain patterns, such as the presence of absolute expressions (“cures all diseases”), excessive use of sensational words, or explicit contradictions with known laws of physics or domain principles. The server converts the results of these rule checks into a rule-based evaluation value, for example by assigning penalty points when specific patterns appear. By combining learned model output with explicit rules, the server implements non-conventional processing that a human operator would not execute consistently or at scale.

The server calculates a final reliability score by combining the model-derived reliability score, the relatedness score, and the rule-based evaluation value using predetermined weightings. The server may apply a formula such as a weighted linear combination and may adjust the weights based on content domain or user group. The server clips the final reliability score within a defined numeric range and stores it in association with the corresponding request.

The server defines one or more threshold values for classifying the final reliability score into discrete reliability levels such as “low,” “medium,” and “high.” The server determines the reliability level for each analysis target information by comparing the final reliability score with the thresholds. The server uses the reliability level to decide whether to generate a warning message and which type of visual or auditory alert to prepare.

The server performs emotion analysis processing to estimate the emotional state of the user. The terminal acquires image information by capturing images or video frames of the user's face through the camera, acquires audio information by recording the user's voice or surrounding sound with the microphone, and acquires operation information such as typing speed, pointer movement, scrolling speed, and timing patterns. The terminal may pre-process those signals, for example by compressing them or extracting basic features, and transmits them to the server under user consent and within privacy constraints. Alternatively, the terminal can locally run an emotion recognition model and only send an emotion label and intensity value to the server.

The server executes an emotion recognition module implemented as a neural network that processes multimodal features. For example, the server uses a convolutional neural network to analyze facial expressions from image frames, a recurrent or transformer-based network to analyze prosodic patterns in audio signals, and a separate network to analyze time series of operation information. The server fuses the outputs of these modality-specific networks in a fusion layer, such as a fully connected layer that takes concatenated feature vectors and outputs probabilities over emotion categories. The server trains this emotion recognition module using labeled emotion datasets and optimizes it by minimizing a loss function such as cross-entropy loss. The server thereby obtains an emotion label (for example, calm, angry, confused, excited, stressed) and an intensity value for each recognized emotion.

The server uses the estimated emotional state to adapt the analysis precision and generative AI model configuration. When the server detects that the user is excited or stressed, the server selects a higher-capacity generative AI model configuration, such as a model with more layers or a larger context window, and adjusts model parameters to produce more detailed and conservative assessments. The server can also increase the number of tokens allowed for model output and can modify the instruction part of the prompt sentence to require explicit listing of uncertainties and recommendations. When the server detects that the user is calm and the content is relatively short, the server selects a lighter model configuration, which reduces computational cost and latency. This emotion-dependent model selection improves overall system efficiency and aligns computational resource usage with user state.

The server generates structured response data that includes both content-level evaluation and presentation control parameters. The server constructs a data record that contains the final reliability score, the reliability level, the warning message when applicable, the explanation information derived from the generative AI model, and presentation control information. The presentation control information includes parameters such as a display color code, a size level for a banner, a flag indicating whether to show an icon, and a numeric level specifying volume for an alert sound. The server transmits this structured response data to the terminal using a secure transport mechanism.

The terminal receives the structured response data and interprets the presentation control information. The terminal maps the display color code to a color palette, determines the size of on-screen elements, enables or disables a warning icon, and adjusts the volume of a warning sound. When the reliability level is low, the terminal displays a prominent banner in a warning color and plays an audible alert. When the reliability level is high, the terminal displays a non-intrusive indicator such as a numeric score or a simple icon. When the user's emotional state is intense, the terminal can adjust the size and color saturation to enhance visibility or reduce stress, as directed by the presentation control information. Thus, the system controls the behavior of display and audio hardware to deliver context-aware warnings.

This architecture improves computer technology in several ways. The server optimizes the data path from user input to model invocation by performing normalization and length control specific to model token constraints, which reduces the risk of model failure and avoids redundant manual intervention. The integrated combination of generative AI output and embedding-based relatedness score allows the server to utilize parallelizable vector computations and structured model outputs, thereby improving both accuracy and computational efficiency compared with rule-only or model-only systems. The explicit prompt sentence templates, coupled with parsing logic that expects structured model responses, enable the server to interpret model outputs deterministically and to combine them algorithmically, rather than treating them as unstructured text.

The use of emotion analysis to control model selection and prompt content causes the server to dynamically allocate processing resources and to tailor evaluation depth in a way that a conventional static pipeline cannot achieve. The server adjusts model parameters and prompt instructions not as a mere business rule, but as a technical feedback mechanism that binds multimodal sensor analysis to machine learning inference behavior. This results in improved performance characteristics: processing latency is reduced for low-risk or low-intensity situations, while analysis quality is enhanced during high-risk or high-intensity conditions. At the same time, the structured response format simplifies client rendering logic, reducing the amount of local computation and decision-making at the terminal and thereby reducing communication overhead by avoiding multiple back-and-forth queries.

In another embodiment, the server uses multiple generative AI models specialized for different domains, such as medicine, finance, or general news. The server stores mappings from content domain indicators to specific model configurations. The server classifies analysis target information into a domain using keyword detection or a domain classifier network, and then selects a corresponding generative AI model and prompt sentence template. This modular configuration allows the server to achieve higher domain-specific precision while maintaining a unified data flow for reliability scoring and response generation.

In a further embodiment, the terminal performs part of the embedding computation locally. The terminal runs a lightweight embedding model on the device to convert text into feature vectors before transmission. The terminal sends compact vectors instead of raw text when privacy or bandwidth is critical. The server then performs similarity comparison using these vectors and uses aggregated similarity results as additional input to the reliability scoring logic. This reduces network bandwidth usage and processing time on the server, since raw text parsing and tokenization can be reduced.

In another variation, the server periodically re-trains or fine-tunes the generative AI model and the embedding model using feedback data. The server collects anonymized statistics about discrepancies between its evaluations and external trusted sources, and maintains logs of user feedback such as indications that a particular judgment was incorrect. The server uses this feedback to update training datasets and to re-run gradient-based training, thereby improving model calibration over time. The server can also adjust weightings in the final score combination formula using optimization methods based on historical evaluation outcomes.

In still another embodiment, the terminal presents granular reliability breakdowns on demand. When the user requests more detail, the terminal displays contributions from the generative AI model reliability score, the relatedness score, and the rule-based evaluation value. The server prepares these components as part of the structured response data. This presentation is not merely a business display; it acts as a debugging and transparency tool that allows operators to monitor the behavior of the computational pipeline and to adjust configuration parameters for better technical performance.

By combining prompt sentence-driven generative AI analysis, embedding-based similarity computation, rule-based evaluation, multimodal emotion recognition, and machine-controlled presentation parameters into a coherent architecture, the system modifies how computers internally process and route data for reliability evaluation. The server and terminal in combination implement specific data structures, model configurations, and control flows that are not inherent in generic computer operation, and that yield improved accuracy, reduced latency, more stable model behavior, and efficient communication patterns compared to conventional approaches. Consequently, the invention provides concrete improvements to the functioning of computer systems used for information reliability assessment and user warning presentation.

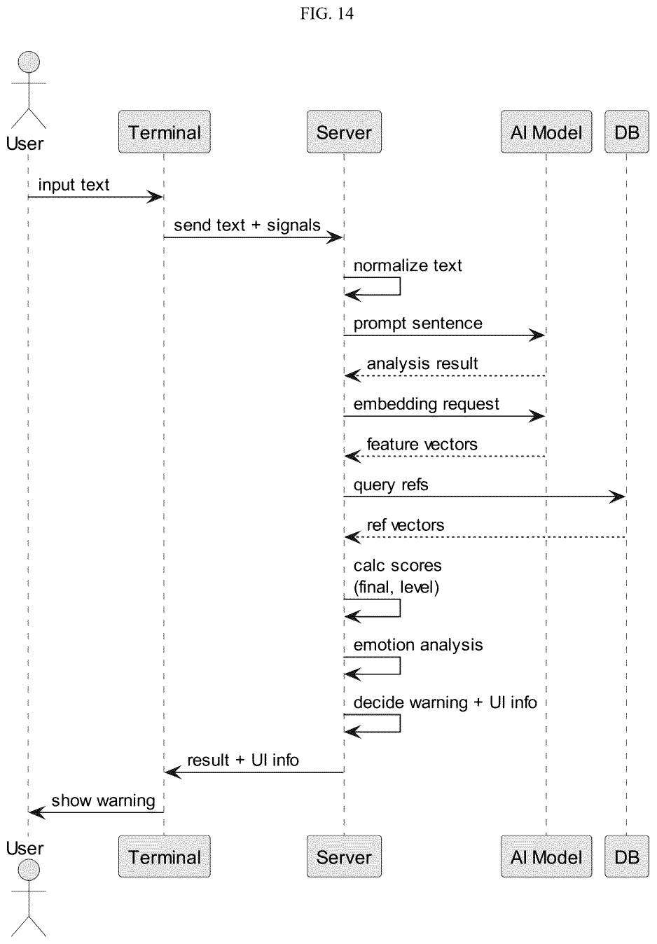

The following describes the processing flow using FIG. 14.

### Step 1

User provides information to terminal.

User inputs text information, such as a news article or a message, into an input field of the terminal, or selects a command to analyze the content currently displayed on the screen. The input is raw information including at least text data and optionally an identifier such as a URL. Terminal receives this raw information as input and stores it temporarily in a local buffer. Terminal may also acquire metadata such as timestamp, language setting, and application context, and associates this metadata with the raw information as part of the output to be sent to the server.

### Step 2

Terminal captures content and emotion-related signals.

Terminal extracts the main text content when the user is viewing a web page or a document by accessing the document object model or application content structures. The input is the page or document data; the output is extracted text content. Terminal additionally acquires emotion-related signals, such as image frames from a camera, audio samples from a microphone, and operation information such as typing speed, scrolling behavior, and pointer movement patterns. Terminal optionally performs basic pre-processing, such as downsampling video frames, compressing audio, and summarizing interaction statistics, thereby converting raw sensor data into reduced feature data. Terminal then prepares a request packet including the text content, metadata, and emotion feature data as the output for server transmission.

### Step 3

Terminal sends analysis request to server.

Terminal uses a secure communication protocol to send the request packet to the server. The input to this step is the packet containing extracted text, metadata, and emotion feature data. Terminal encapsulates the packet into a network message and transmits it through the communication interface. The output is the transmitted message over the encrypted communication channel, which becomes the input for the server.

### Step 4

Server receives and validates request.

Server receives the network message from the terminal via the communication interface. The input is the request packet containing text, metadata, and emotion feature data. Server parses the packet, verifies the message format, and checks for required fields such as text content and a request identifier. Server may perform access control checks and rate limiting. Server stores the parsed request data into working memory and logs a record including the request identifier and basic attributes into a storage device. The output is a validated request data structure ready for normalization and analysis.

### Step 5

Server normalizes and truncates text into analysis target information.

Server reads the raw text from the validated request data structure as input. Server performs character encoding normalization, white space normalization, and removal of markup, scripts, and boilerplate segments. Server applies language detection and may apply language-specific formatting operations such as lowercasing and script unification. Server uses a tokenization procedure to estimate token count and truncates or segments the text so that the total tokens fit within the input limit of the generative AI model. Server selects important sections such as titles and leading paragraphs when truncation is necessary. The output is analysis target information, a normalized and length-controlled text representation suitable for model input.

### Step 6

Server constructs a prompt sentence for the generative AI model.

Server takes the analysis target information and prompt template configuration as input. Server selects an appropriate template based on content category and system settings. For example, server can generate a prompt sentence such as:

“You are a fact-checking assistant. Evaluate the reliability of the following information. Provide: (1) a reliability score from 0 to 100, (2) a brief explanation, and (3) the main claims that should be checked.

Text: ‘“[ANALYSIS_TARGET_INFORMATION]’””

Server replaces the placeholder with the actual analysis target information and, if needed, appends additional instructions regarding caution or uncertainty handling. The output is a complete prompt sentence string that encodes both user content and detailed instructions for the generative AI model.

### Step 7

Server invokes the generative AI model using the prompt sentence.

Server uses the constructed prompt sentence as input to a generative AI model execution component. Server selects a model configuration, such as model size and maximum output length, based on system settings and possibly on preliminary emotion indicators. Server forwards the prompt sentence to the model, which executes multiple neural network layers, including attention and feedforward layers, to generate a response. Server receives the model-generated text output, which contains an estimated reliability score, explanation, and identified main claims according to the instructions in the prompt sentence. The output of this step is the raw model response text.

### Step 8

Server parses model output into analysis result components.

Server takes the raw model response text as input. Server applies parsing logic that searches for predefined markers, keywords, or structured patterns such as “Score:” or enumerated lists of claims. Server extracts a model-derived reliability score, an explanation text, and main-claim information, and converts the reliability score into a numeric value within a known range. Server constructs an analysis result record that contains these elements. The output is a structured analysis result data structure with fields for reliability score, explanation information, and main-claim information.

### Step 9

Server generates feature data for similarity comparison.

Server uses the analysis target information and the main-claim information as input texts for an embedding model. Server applies the embedding model to compute one or more numerical feature vectors that represent semantic characteristics of the texts. The embedding model performs operations such as token embedding lookup, multi-layer encoding, and aggregation of hidden states into a fixed-dimensional vector. The output is feature data consisting of one or more embedding vectors for the analysis target information and optionally for each main claim.

### Step 10

Server computes relatedness score against reference information.

Server takes the feature data of the analysis target information and feature data of stored reference information as input. Server retrieves relevant reference vectors from the storage device, either by scanning or by querying an index structure. Server calculates similarity metrics, such as cosine similarity, between the analysis target vector and each retrieved reference vector. Server aggregates the similarity values, for example by taking an average of top-ranked similarities, and normalizes the result into a standardized numerical range. The output is a relatedness score representing how closely the incoming information aligns with reference information.

### Step 11

Server applies rule-based evaluation to derive a rule-based value.

Server uses the analysis target information, main-claim information, and possibly metadata as input to a rule-based evaluation engine. Server performs checks for patterns such as absolute claims, contradictory statements, or known misleading phrases. Server assigns penalty or bonus points according to which rules are triggered and sums these points or transforms them into a normalized rule-based evaluation value. The output is a rule-based evaluation value that quantifies heuristic risk or reliability based on explicit rules.

### Step 12

Server combines scores to calculate a final reliability score and level.

Server takes the model-derived reliability score, the relatedness score, and the rule-based evaluation value as input. Server applies a combination formula, such as a weighted sum or another aggregation function, to compute a final reliability score. Server ensures the result lies within a predetermined numeric range and may round it to a specified precision. Server then compares the final reliability score with predefined thresholds to assign a reliability level such as low, medium, or high. The output is a final reliability score and a discrete reliability level.

### Step 13

Server estimates user emotional state from emotion-related data.

Server receives emotion-related data, such as image-based features, audio-based features, or operation information, from the terminal as input. Server processes these data using an emotion recognition model that may combine multiple neural networks for different modalities. Server produces probabilities for various emotion categories and derives a dominant emotional state and an intensity measure for that state. The output is an emotion label (for example, angry, calm, confused, excited, stressed) and an associated intensity value.

### Step 14

Server adjusts analysis mode and prompt configuration according to emotional state.

Server uses the emotion label, emotion intensity, and content category as input. If the emotion intensity is high or the emotion type suggests urgency, server updates its analysis mode configuration by selecting a more detailed generative AI model, increasing allowable output length, and reinforcing cautious instructions in the prompt template. If the emotion intensity is low and the content is routine, server may use a lighter model configuration. Server records the chosen mode and updated instruction settings. The output is an adjusted model configuration and, if analysis is re-run for higher precision, an updated prompt sentence and analysis result; if analysis is not re-run, the output is a mode selection recorded for logging and future parameter tuning.

### Step 15

Server generates warning message and presentation control information.

Server uses the final reliability score, reliability level, explanation information, and emotion label as input. Server generates a warning message when the reliability level is low or within a cautionary band, using the explanation information to produce understandable text for the user. Server determines presentation control information, including display color selection, banner size level, icon presence flag, and alert sound volume, based on both reliability level and emotion state. For example, server selects a bright warning color and higher volume for low reliability and high-intensity emotions, and a softer scheme when the user appears calm. The output is a structured response payload that includes the warning message, the final reliability score, the reliability level, and the presentation control information.

### Step 16

Server sends structured response payload to terminal.

Server takes the structured response payload as input for transmission. Server serializes the payload into a message format and sends it to the terminal through the secure communication channel. Server logs key values such as final reliability score, reliability level, and chosen presentation parameters for monitoring and future optimization. The output is a network message delivered to the terminal containing all data required for presentation and further client-side behavior.

### Step 17

Terminal renders warnings and reliability indicators.

Terminal receives the structured response payload from the server as input. Terminal parses the warning message, final reliability score, reliability level, and presentation control information. Terminal maps the presentation control information to specific UI actions: Terminal sets the banner color and size, shows or hides a warning icon, and sets the alert sound volume. Terminal displays the warning message and reliability score on the display, for example as a colored banner with text and numeric score, and plays an alert sound through the audio output device if directed. The output is a real-time visual and auditory presentation that reflects the reliability evaluation and is adapted to the user's emotional state.

### Step 18

User reviews feedback and chooses subsequent action.

User observes the warning message, reliability score, and explanation on the terminal's display as input information. User may decide to stop reading the content, to cross-check with other sources, or to proceed despite the warning. User may also provide explicit feedback, such as indicating disagreement with the system's judgment. Terminal can capture this feedback and send it back to the server for logging or future model refinement. The output of this step is the user's decision and optional feedback, which can influence subsequent system behavior and long-term model adjustments.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

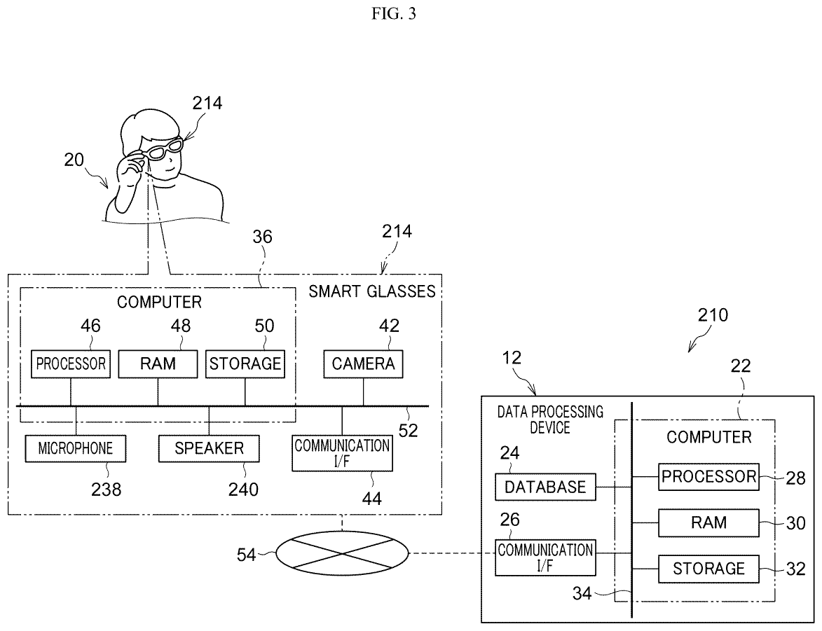

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

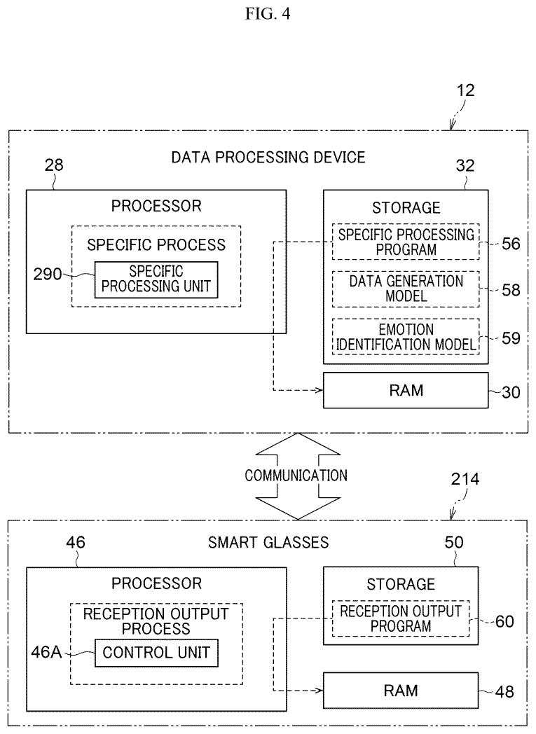

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

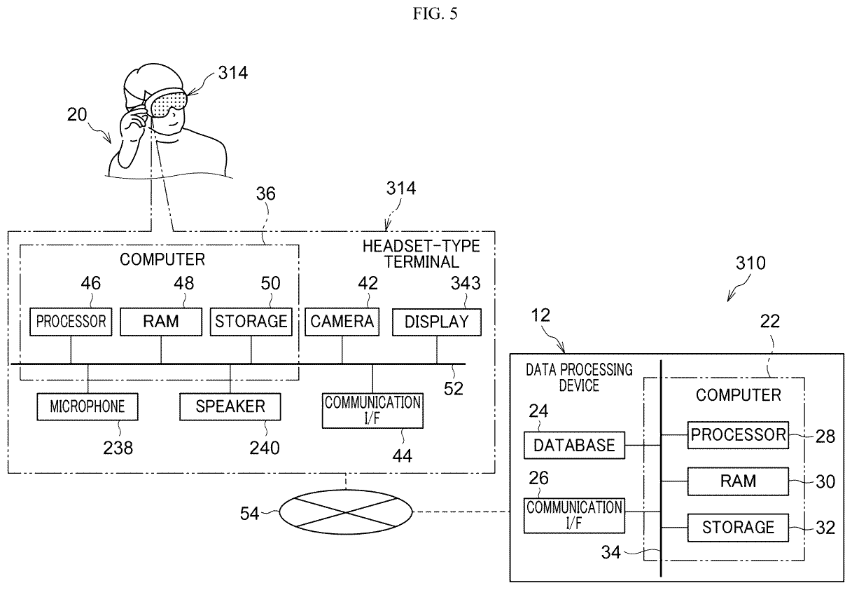

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

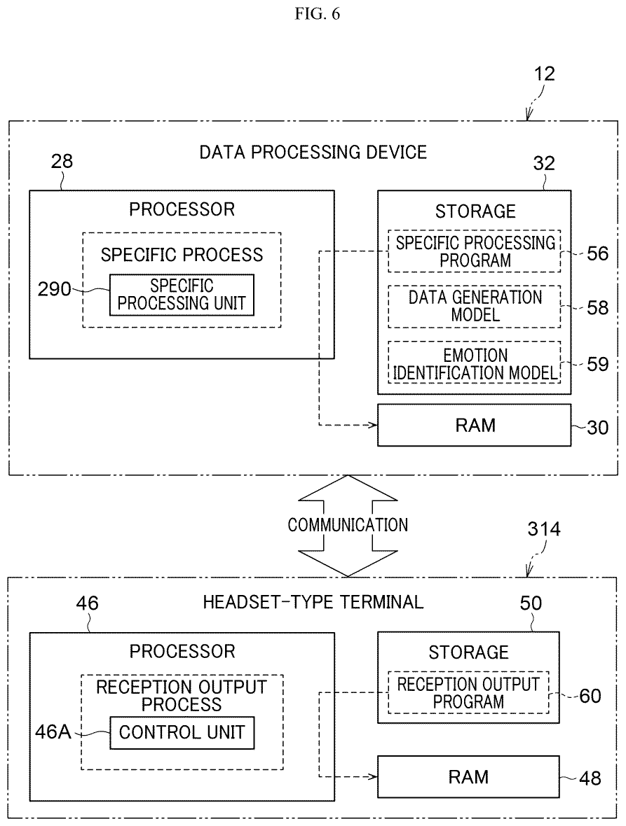

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

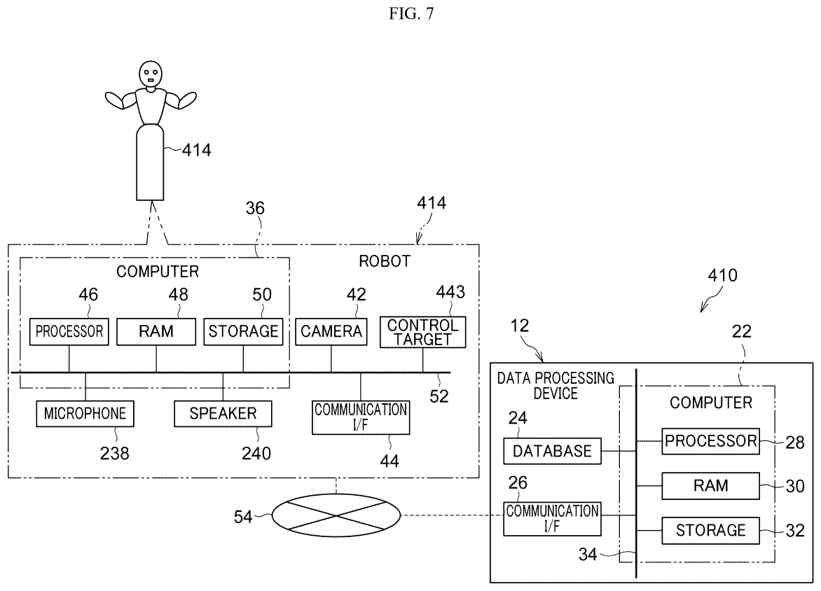

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

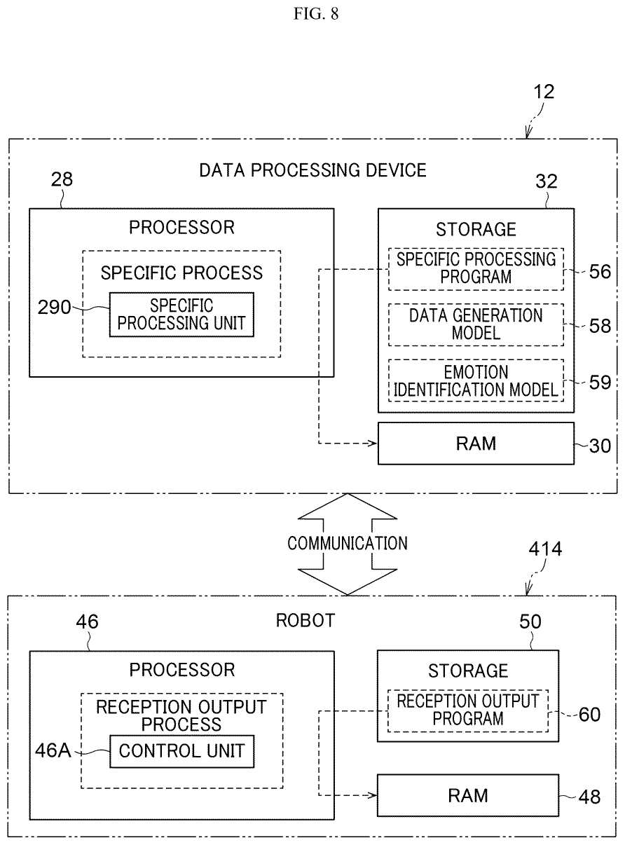

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

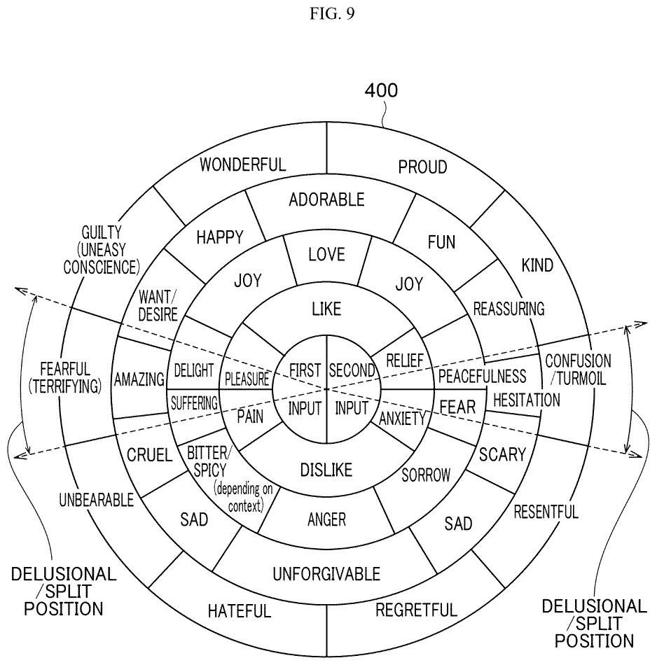

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

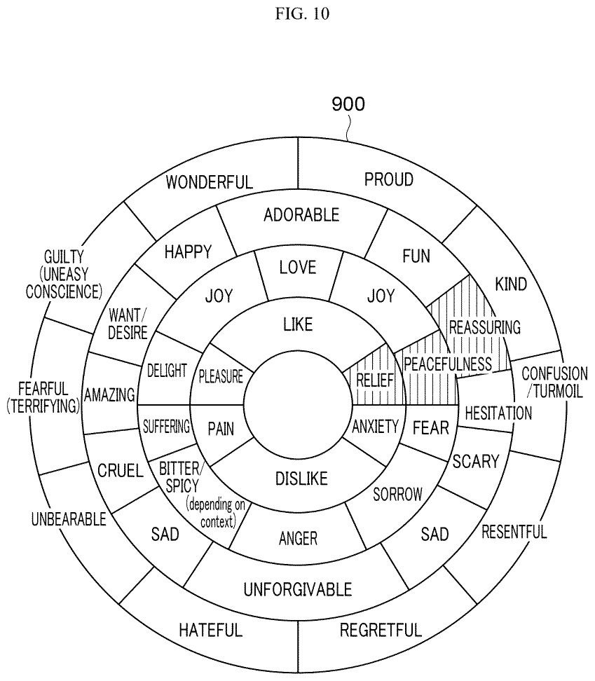

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
receive character information input by a user from a terminal device,
generate a prompt sentence for causing a generative information processing model to analyze content of the character information, and input the prompt sentence and the character information into the generative information processing model to obtain structured information regarding the character information,
generate a numerical vector as a feature quantity of the character information based on the structured information,
compare the numerical vector with a plurality of numerical vectors stored in association with an existing information set held in a storage device, and calculate a relevance score indicating relevance between the character information and the existing information set,
generate warning information indicating that relevance or reliability of the character information is low when the relevance score is lower than a predetermined criterion,
output the warning information visually or auditorily to the user terminal as a warning output,
analyze an emotional state of the user based on input content or operation information from the user, and adjust a presentation mode of the warning output according to the emotional state, and
perform sequential processing from input of the character information to calculation of the relevance score and presentation of the warning information by connecting the user terminal and the processor via real-time communication.

### Supplementary 2

The system according to supplementary 1,
wherein the processor is configured to
use a trained information processing model that performs natural language processing as the generative information processing model, embed the character information into the prompt sentence, and obtain the structured information including keywords, topics, and a summary from the trained information processing model.

### Supplementary 3

The system according to supplementary 1,
wherein the processor is configured to
use a vector-search information storage device that stores the plurality of numerical vectors associated with the existing information set in the comparison, and calculate the relevance score based on similarity between the numerical vector and the plurality of numerical vectors.

### Application Example 1

### Supplementary 1

A system comprising a processor and a storage device,
wherein the processor is configured to
receive input information from a user via an input interface,
generate a prompt sentence for analyzing the input information, and input the prompt sentence and the input information into a generative AI model to cause the generative AI model to analyze a semantic content and an intention of the input information,
compare an analysis result from the generative AI model and the input information with past information stored in the storage device, and calculate a relevance score and an anomaly score based on similarity computation or anomaly detection computation,
determine, based on the relevance score and the anomaly score, whether the input information deviates from a normal communication pattern or has a risk of confidential information leakage, and generate alert information when the input information is determined to have low reliability or high security risk,
analyze an emotional state of the user from spoken content or text content using the generative AI model, and adjust an output method or notification content of the alert information according to the emotional state,
perform communication processing to transmit the alert information to an administrator terminal or a monitoring terminal, and
record at least the input information, the analysis result, the relevance score, the anomaly score, and the alert information in the storage device.

### Supplementary 2

The system according to supplementary 1,
wherein the processor is configured to cooperate with an in-house communication medium to provide a user interface that receives the input information from the user in real time, and automatically execute the analysis by the generative AI model and the calculation of the relevance score at a time of transmission of the input information.

### Supplementary 3

The system according to supplementary 1,
wherein the processor is configured to present the alert information as a visual notification or an auditory notification to at least one of the user and an administrator, and change at least one of a notification medium, a notification intensity, and a notification frequency in accordance with the emotional state of the user and a security risk of the input information.

### Example 2

### Supplementary 1

A system comprising a processor,
wherein the processor is configured to
receive character information input from a user via an information terminal and generate a prompt sentence including the character information for instructing analysis by a generative AI model,
input the prompt sentence to the generative AI model and, by natural language processing performed by the generative AI model, extract summary information and claim information from the character information,
normalize the extracted claim information and generate, based on the normalized claim information, a search condition or a feature amount for acquiring reliability information stored in a data storage device,
search the data storage device using the search condition or the feature amount and calculate a relevance score based on similarity or relatedness between the claim information and the reliability information,
calculate a reliability index of the character information based on the relevance score and at least one of a number of items of the reliability information and time series information of the reliability information, and determine a reliability level of the character information according to the reliability index,
analyze an emotional state of the user and, when the reliability level is determined to be low,
adjust content and an output format of a warning message according to the emotional state and output the warning message to the information terminal, and
perform a communication process for continuously accepting input from the user and sequentially returning the reliability level of the character information and the warning message to the information terminal.

### Supplementary 2

The system according to supplementary 1,
wherein the processor is configured to
select or generate the prompt sentence used as input to the generative AI model from a plurality of prompt sentence candidates according to a field type or a format type of the character information, and generate the prompt sentence including a description that instructs a structured format of the claim information to be extracted.

### Supplementary 3

The system according to supplementary 1,
wherein the processor is configured to
specify related information or alternative information corresponding to the character information based on the reliability information acquired from the data storage device, and, when the reliability level is determined to be low, include reference information to the related information or the alternative information in the warning message and present the reference information to the information terminal.

### Application Example 2

### Supplementary 1

A system comprising a processor,
wherein the processor is configured to
receive information from a user terminal and generate analysis target information by normalizing the received information, formatting characters and white spaces, and truncating the received information to a predetermined length so that the analysis target information is suitable for input to a generative AI model,
generate a prompt sentence for instructing a reliability evaluation of the analysis target information by inserting the analysis target information into a predetermined template, the prompt sentence requesting the generative AI model to output a reliability score, an explanation of a basis of the reliability score, and a list of main claims to be verified,
input the prompt sentence to the generative AI model to cause the generative AI model to analyze contents of the analysis target information, and extract, from an output of the generative AI model, an analysis result including the reliability score, explanation information, and main-claim information,
generate feature data by calculating vector representations of at least one of the analysis target information and the main-claim information using at least one of the generative AI model and an embedding model, and calculate a relatedness score based on a similarity between the feature data and feature data of reference information stored in a storage device,
calculate a final reliability score of the analysis target information by combining the reliability score, the relatedness score, and a rule-based evaluation value with predetermined weightings, and determine a reliability level of the analysis target information by comparing the final reliability score with a threshold value,
generate, when the reliability level is determined to be low or within a predetermined range, a warning message for a user using the explanation information in the analysis result, and output structured response data including the warning message, the final reliability score, and the reliability level,
estimate an emotional state of the user and an intensity of the emotional state by performing emotion analysis processing based on at least one of image information, audio information, and operation information acquired from the user terminal,
adjust an analysis precision by changing at least one of a type of the generative AI model to be used, a number of generated tokens, and an analysis detail level to switch an analysis mode, or by changing an instruction content in the prompt sentence, in accordance with the emotional state and a type of the analysis target information, and
determine presentation control information indicating at least one of a display color, a display size, presence or absence of an icon, and presence, absence, or volume of an alert sound for the warning message based on the emotional state and the reliability level, and transmit the response data with the presentation control information to the user terminal.

### Supplementary 2

The system according to supplementary 1,
wherein the processor is configured to
sequentially receive, via an encrypted communication channel, information including text data or an identifier transmitted from the user terminal, and, upon each reception, perform generation of the prompt sentence, analysis by the generative AI model, calculation of the relatedness score and the final reliability score, and transmission of the response data, thereby executing a reliability evaluation process in real time while the user is viewing the information.

### Supplementary 3

The system according to supplementary 1,
wherein the processor is configured to
cause the user terminal to present, based on the reliability level and the presentation control information included in the response data, a visual or auditory warning using at least one of an emphasized-color banner, a warning icon, and an alert sound when the reliability is low, and to display the reliability score as a numerical indicator or a graphical indicator when the reliability is high, and to adjust at least one of a color tone, a size, and a volume of the warning in accordance with the estimated emotional state of the user.

What is claimed is:

1. A system comprising:
circuitry configured to:
receive, via a communication interface coupled to a packet-switched network, character information input by a user from a terminal device;
generate a prompt sentence for instructing a generative neural network model to analyze content of the character information, and transmit the prompt sentence and the character information to the generative neural network model via the communication interface to obtain structured information regarding the character information;
generate a numerical vector as a feature quantity of the character information based on the structured information, and compare the numerical vector with a plurality of numerical vectors stored in association with an existing information set in a vector-search-capable storage device to calculate a relevance score indicating relevance between the character information and the existing information set;
generate notification information indicating that relevance of the character information is below a criterion when the relevance score is lower than a predetermined threshold, and transmit the notification information to the terminal device via the communication interface; and
analyze a user state of the user based on input content or operation information received from the terminal device, and adjust a presentation mode of the notification information according to the user state prior to transmitting the notification information.

2. The system according to claim 1, wherein the circuitry is configured to use a trained natural language processing model as the generative neural network model, embed the character information into the prompt sentence, and obtain the structured information comprising keywords, topics, and a summary from the trained natural language processing model.

3. The system according to claim 2, wherein the circuitry is configured to apply a keyword extraction validation function to the structured information to verify that the extracted keywords match a predefined schema, and to regenerate the prompt sentence with additional formatting constraints when the keyword extraction validation function detects a schema mismatch.

4. The system according to claim 2, wherein the circuitry is configured to apply a topic classification function to the structured information to assign the character information to a predefined category, and to restrict the comparison of the numerical vector to a subset of the plurality of numerical vectors associated with the assigned category in the vector-search-capable storage device.

5. The system according to claim 1, wherein the circuitry is configured to use a vector-search-capable storage device that stores the plurality of numerical vectors associated with the existing information set, and to calculate the relevance score based on a cosine similarity or an inner product similarity between the numerical vector and the plurality of numerical vectors.

6. The system according to claim 5, wherein the circuitry is configured to retrieve, from the vector-search-capable storage device, a ranked list of the top-k most similar numerical vectors and their associated existing information entries, and to include the ranked list as supporting evidence in the notification information transmitted to the terminal device.

7. The system according to claim 5, wherein the circuitry is configured to apply an approximate nearest neighbor search algorithm to the vector-search-capable storage device to compute the relevance score with reduced computational latency, and to store the approximate nearest neighbor search index in the vector-search-capable storage device as an updatable index structure.

8. The system according to claim 1, wherein the circuitry is configured to apply an emotion recognition function to the operation information from the terminal device to classify the user state into a plurality of predefined categories, and to select a presentation parameter set from a parameter table stored in a storage device based on the classified category, wherein the presentation parameter set specifies at least one of a visual modality, an auditory modality, an intensity level, or a message wording for the notification information.

9. The system according to claim 8, wherein the circuitry is configured to receive a user preference setting from the terminal device via the communication interface specifying a preferred presentation modality, and to apply the user preference setting as an override to the presentation parameter set when the classified user state category is below a predefined severity threshold.

10. The system according to claim 8, wherein the circuitry is configured to log each user state classification, the corresponding presentation parameter set applied, and a user acknowledgment response received from the terminal device in a storage device as interaction history data, and to apply a presentation optimization function to the interaction history data to update the parameter table.

11. The system according to claim 1, wherein the circuitry is configured to perform sequential processing from receipt of the character information to calculation of the relevance score and transmission of the notification information by maintaining a persistent connection with the terminal device via the communication interface.

12. The system according to claim 11, wherein the circuitry is configured to compute a processing latency metric for each execution of the sequential processing, and to apply an adaptive load balancing function to distribute subsequent requests across available processing resources when the processing latency metric exceeds a target latency threshold.

13. The system according to claim 1, wherein the circuitry is configured to update the existing information set stored in the vector-search-capable storage device by adding a new numerical vector generated from newly received character information when the relevance score of the newly received character information exceeds a predetermined update threshold.

14. The system according to claim 13, wherein the circuitry is configured to apply a deduplication function to the new numerical vector prior to storing it, by computing a similarity between the new numerical vector and the plurality of existing numerical vectors and excluding the new numerical vector when a nearest-neighbor similarity exceeds a deduplication threshold.

15. The system according to claim 1, wherein the circuitry is configured to generate a comparative prompt sentence that embeds both the structured information and a selected subset of the existing information set retrieved from the vector-search-capable storage device, transmit the comparative prompt sentence to the generative neural network model, and obtain a natural language explanation of the relevance score as part of the notification information.

16. The system according to claim 15, wherein the circuitry is configured to apply a readability assessment function to the natural language explanation to compute a readability score, and to regenerate the comparative prompt sentence with a simplified output format instruction when the readability score falls below a threshold associated with the user state.

17. The system according to claim 1, wherein the circuitry is configured to apply a confidence scoring function to the structured information obtained from the generative neural network model to assign a confidence score to each element of the structured information, and to apply a weighted vector generation function that assigns higher weights to high-confidence elements when computing the numerical vector.

18. A system comprising:
circuitry configured to:
receive, via a communication interface coupled to a packet-switched network, character information from a terminal device, generate a prompt sentence for instructing a generative neural network model to analyze content of the character information, and transmit the prompt sentence and the character information to the generative neural network model via the communication interface to obtain structured information comprising keywords, topics, and a summary;
generate a numerical vector as a feature quantity of the character information based on the structured information, apply a vector similarity computation against a plurality of numerical vectors stored in a vector-search-capable storage device to calculate a relevance score, and retrieve a ranked list of top-k most similar entries from the vector-search-capable storage device;
generate notification information indicating that relevance of the character information is below a threshold when the relevance score is lower than a predetermined criterion, and include the ranked list as supporting evidence in the notification information; and
analyze a user state based on input content or operation information received from the terminal device, select a presentation parameter set from a parameter table stored in a storage device based on the user state, and transmit the notification information to the terminal device via the communication interface using the presentation parameter set.

19. The system according to claim 18, wherein the circuitry is configured to update the existing information set in the vector-search-capable storage device by adding a numerical vector generated from newly received character information when the relevance score exceeds a predetermined update threshold, and to apply a deduplication function prior to storing the new numerical vector.

20. A method comprising:
receiving, via a communication interface coupled to a packet-switched network, character information input by a user from a terminal device;
generating a prompt sentence for instructing a generative neural network model to analyze content of the character information, and transmitting the prompt sentence and the character information to the generative neural network model via the communication interface to obtain structured information regarding the character information;
generating a numerical vector as a feature quantity of the character information based on the structured information, and comparing the numerical vector with a plurality of numerical vectors stored in association with an existing information set in a vector-search-capable storage device to calculate a relevance score;
generating notification information indicating that relevance of the character information is below a criterion when the relevance score is lower than a predetermined threshold, and transmitting the notification information to the terminal device via the communication interface; and
analyzing a user state of the user based on input content or operation information received from the terminal device, and adjusting a presentation mode of the notification information according to the user state prior to transmitting the notification information.
